(19) United States
(12) Patent Application Publication
(10) Pub. No.: US 2026/0077597 A1
(43) Pub. Date: Mar. 19, 2026

(54) CARTRIDGE

(71) Applicant: KEYENCE CORPORATION, Osaka (JP)

(72) Inventors: Yu Takabatake, Osaka-shi (JP); Hajime Hashimoto, Osaka-shi (JP); Mamoru Idaka, Osaka-shi (JP)

(73) Assignee: KEYENCE CORPORATION, Osaka (JP)

(21) Appl. No.: 19/325,867

(22) Filed: Sep. 11, 2025

(30) Foreign Application Priority Data
Sep. 18, 2024 (JP) 2024-160589

(51) Int. Cl. B41J 2/175

(52) U.S. Cl. CPC B41J 2/17526; B41J 2/17513; B41J 2/17523; B41J 2/17553; B41J 2002/17516

(57) ABSTRACT

A cartridge is made compact in a height direction, and connectivity of terminals provided in the cartridge is improved. The cartridge includes an outer case, a recording medium that records information regarding the cartridge, an access terminal that is electrically connected to the recording medium and is accessed from a terminal on a side of a drawing machine via a cartridge receiving section, and a holding member that holds the recording medium and the access terminal and is supported by the outer case to be switchable between an advanced position where the access terminal is in contact with the terminal on the side of the drawing machine and a retracted position where the access terminal is away from the terminal on the side of the drawing machine.

### CROSS-REFERENCE TO RELATED APPLICATIONS

The present application claims foreign priority based on Japanese Patent Application No. 2024-160589, filed Sep. 18, 2024, the contents of which are incorporated herein by reference.

### BACKGROUND OF THE INVENTION

### 1. Technical Field

The present disclosure relates to a cartridge for refilling ink to a drawing machine.

### 2. Description of the Related Art

For example, a drop on demand (DOD) type inkjet print apparatus that performs printing by ejecting ink onto a packaging material such as cardboard is known (See, for example, JP2020-131141A).

In the inkjet print apparatus of JP2020-131141A, a large reservoir for accommodating ink is provided on a side of a print head that ejects ink.

However, in a case where the reservoir is provided as in JP2020-131141A, when it is necessary to refill the ink, complicated work such as pouring refill ink after opening a lid of the reservoir, and closing the lid after pouring the ink is required, which is inconvenient. Furthermore, when pouring the refill ink into the reservoir, the refill ink may spill and contaminate the surrounding environment.

In this respect, for example, if a cartridge is used, the refill of the ink is completed only by performing an attaching and detaching operation of the cartridge, and thus it is considered that the spillage of the refill ink does not occur and the contamination of the surrounding environment can be prevented.

However, in general, since the cartridge often has an elongated shape extending along an insertion direction at the time of attachment to a housing, when a capacity of the cartridge is increased, a length of the cartridge protruding from an outer surface of the housing increases, and the convenience of the user is hindered.

Furthermore, by providing in the cartridge a recording medium in which information regarding the cartridge is recorded, for example, the recording medium may be used for ink quality control and the like. In this case, it is also necessary to prevent electrical connection failure between a terminal connected to the recording medium of the cartridge and a terminal provided on a drawing machine side in a state where the cartridge is attached to the drawing machine.

### SUMMARY OF THE INVENTION

The present disclosure has been made in view of such a point, and an object of the present disclosure is to make a cartridge compact in a height direction and to improve connectivity of terminals provided in the cartridge.

In order to achieve the above object, a cartridge according to one embodiment of the present disclosure can be assumed to be a cartridge that is inserted into a cartridge receiving section provided in a drawing machine that ejects ink for drawing information on an object to be drawn conveyed by a conveyor and refills the drawing machine with ink. A cartridge includes: an ink accommodation section configured to accommodate ink; a conduit member including a flow path communicating with an internal space of the ink accommodation section; an outer case configured to support the conduit member and expose one end of the conduit member to an outside; a recording medium configured to record information regarding the cartridge; an access terminal electrically connected to the recording medium and configured to be accessed from a terminal on a side of the drawing machine via the cartridge receiving section; and a holding member configured to hold the recording medium and the access terminal and be supported by the outer case to be switchable between an advanced position where the access terminal is in contact with the terminal on the side of the drawing machine and a retracted position where the access terminal is away from the terminal on the side of the drawing machine.

According to this configuration, since it is only necessary to replace the cartridge when the ink is refilled, the refill ink does not spill, contamination of the surrounding environment can be prevented, and complicated work is not required for the user. Furthermore, since the cartridge is inserted into the cartridge receiving section of a housing, it is possible to secure a sufficient capacity of the cartridge while achieving compactness in a height direction of the cartridge. Moreover, the access terminal can be brought into contact with the terminal on the side of the drawing machine by switching the holding member to the advanced position.

As described above, the cartridge can be made compact in the height direction, and the connectivity of the terminals provided in the cartridge can be improved.

### BRIEF DESCRIPTION OF THE DRAWINGS

FIG. 1 is a diagram illustrating an overall configuration of an inkjet print apparatus according to an embodiment of the present invention;

FIG. 2 is a block diagram of an inkjet print apparatus;

FIG. 3 is a plan view illustrating an installation example of a drawing machine and an inspection machine;

FIG. 4 is a front view illustrating an installation example of the drawing machine and the inspection machine;

FIG. 5 is a perspective view of the drawing machine as viewed from the front;

FIG. 6 is a view corresponding to FIG. 5 illustrating a state in which a cartridge is detached;

FIG. 7 is a front view of the drawing machine;

FIG. 8 is a perspective view of the drawing machine with the cartridge detached as viewed from behind;

FIG. 9 is a perspective view of the drawing machine with the cartridge detached as viewed from above;

FIG. 10 is a cross-sectional view taken along line X-X in FIG. 9;

FIG. 11 is a view corresponding to FIG. 10 illustrating a state in the middle of receiving the cartridge;

FIG. 12 is a view corresponding to FIG. 10 illustrating a state in which the cartridge is completely received;

FIG. 13 is a perspective view of the cartridge;

FIG. 14 is a plan view of the cartridge;

FIG. 15 is a bottom view of the cartridge;

FIG. 16 is a front view of the cartridge;

FIG. 17 is a back view of the cartridge;

FIG. 18 is a right side view of the cartridge;

FIG. 19 is a left side view of the cartridge;

FIG. 20 is a perspective view of a ROM unit;

FIG. 21 is a cross-sectional view taken along line XXI-XXI in FIG. 18, and illustrates a case where a holding member is at an advanced position;

FIG. 22 is a view corresponding to FIG. 21 in a case where the holding member is at a retracted position;

FIG. 23 is a cross-sectional view of the periphery of a ROM unit and a switching section according to Modification 1 of the embodiment;

FIG. 24A is a cross-sectional view of the periphery of a ROM unit and a switching section according to Modification 2 of the embodiment, and illustrates a case where the ROM unit is at the retracted position;

FIG. 24B is a view corresponding to FIG. 24A illustrating a state in which the ROM unit is in the process of switching to the advanced position;

FIG. 24C is a view corresponding to FIG. 24A illustrating a state in which the ROM unit has switched to the advanced position;

FIG. 25A is a cross-sectional view of the periphery of a ROM unit and a switching section according to Modification 3 of the embodiment, and illustrates a case where the ROM unit is at the retracted position;

FIG. 25B is a view corresponding to FIG. 25A, illustrating a state in which the ROM unit is just before switching to the advanced position;

FIG. 25C is a view corresponding to FIG. 25A illustrating a state in which the ROM unit is in the process of switching to the advanced position;

FIG. 25D is a view corresponding to FIG. 25A illustrating a state in which the ROM unit has switched to the advanced position;

FIG. 26 is a perspective view of the drawing machine with an upper cover detached as viewed from above;

FIG. 27 is a perspective view illustrating a state in which a casing accommodating an absorber is detached;

FIG. 28 is a perspective view illustrating a state in which an ink reception portion is detached;

FIG. 29 is a view illustrating a positional relationship between a print head, the ink reception portion, and an ink tank, as viewed from above;

FIG. 30 is a cross-sectional view of the ink reception portion;

FIG. 31 is a perspective view of a cartridge according to Modification 4 of the embodiment as viewed from below;

FIG. 32 is a perspective view of the cartridge according to Modification 4 of the embodiment as viewed from above; and

FIG. 33 is a perspective view illustrating a structure of a cartridge according to Modification 5 of the embodiment.

### DETAILED DESCRIPTION

Hereinafter, embodiments of the present invention will be described in detail with reference to the drawings. Note that the following description of preferred embodiments is merely exemplary in nature and is not intended to limit the present invention, its application, or its use.

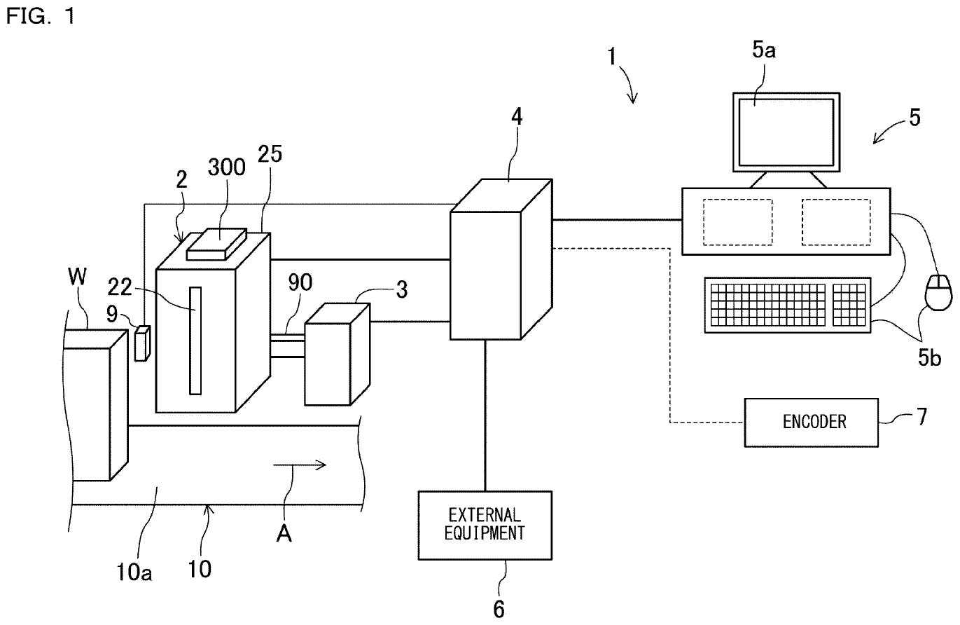

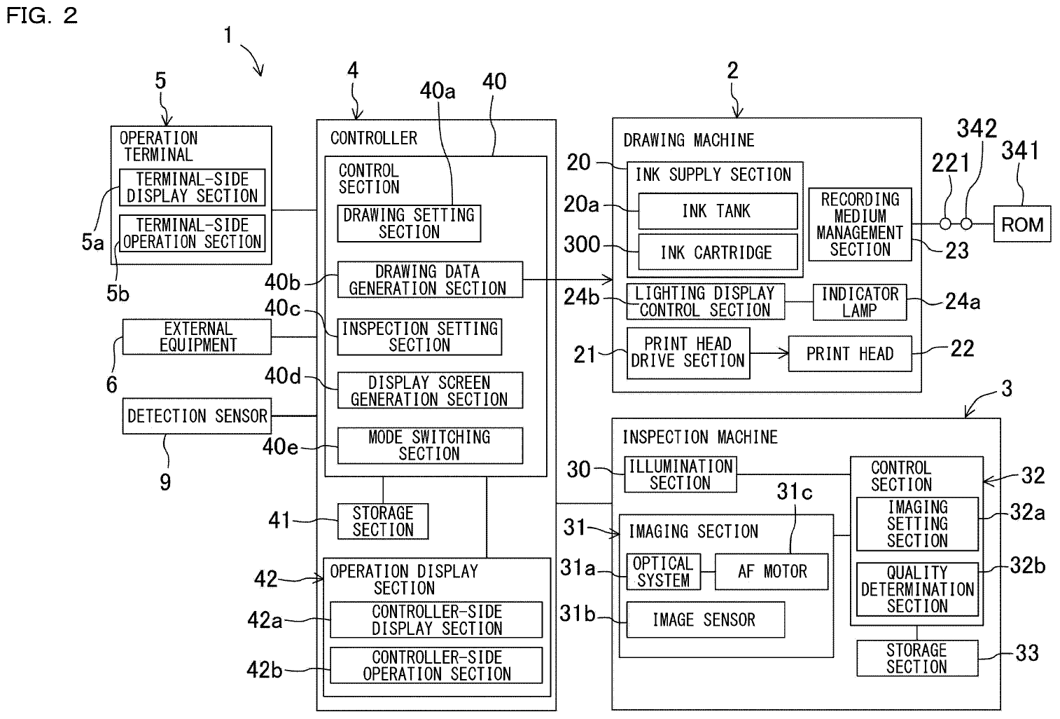

FIG. 1 is a diagram schematically illustrating an overall configuration at the time of operation of an inkjet print apparatus 1 including a drawing machine 2 according to an embodiment of the present invention, and FIG. 2 is a block diagram of the inkjet print apparatus 1. The inkjet print apparatus 1 includes, for example, a drawing machine 2, an inspection machine 3, a controller 4, and an operation terminal 5.

The drawing machine 2 is a part that performs drawing processing on an object to be drawn, and is configured separately from the controller 4. The inspection machine 3 is a part that determines the quality of the drawing state executed on the object to be drawn by the drawing machine 2, and is configured separately from the controller 4. Since the inkjet print apparatus 1 according to the present embodiment includes the drawing machine 2 and the inspection machine 3, the inkjet print apparatus 1 is an inkjet print apparatus that ejects ink for drawing information onto an object and determines the quality of a drawing state by imaging.

The controller 4 is a part that controls the drawing machine 2 and the inspection machine 3, and can also be referred to as a control device, a control unit, or the like. Furthermore, the operation terminal 5 includes a personal computer or the like, and is a part where a user inputs drawing information, performs various settings, selects, confirms, and the like, for example. The operation terminal 5 includes a terminal-side display section 5a including, for example, a liquid crystal display, and a terminal-side operation section 5b including a keyboard, a mouse, a pointing device, and the like.

The above configuration example is an example, and the present invention is not limited to the above configuration example. That is, the controller 4 may be incorporated into the operation terminal 5 or may be incorporated into the drawing machine 2. Furthermore, the operation terminal 5 may function as the controller 4. Furthermore, FIGS. 1 and 2 illustrate external equipment 6 including a programmable logic controller (PLC) or the like, and the external equipment 6 is communicably connected to the controller 4. A control signal output from the external equipment 6 is input to the controller 4. The external equipment 6 may be equipment constituting a part of the inkjet print apparatus 1, or may be equipment different from the inkjet print apparatus 1.

The inkjet print apparatus 1 is an apparatus for forming a drawing pattern on a workpiece W (an example of a drawing object) conveyed in a horizontal direction by a conveyor (an example of a conveyance device) 10, and is an in-line apparatus used by being incorporated in a manufacturing line (also referred to as a production line). The conveyor 10 is, for example, a belt conveyor, a roller conveyor, or the like. The production line is configured by the conveyor 10. The production line is installed in various factories, warehouses, and the like. The drawing machine 2 is fixed such that the relative position with respect to the conveyor 10 has a predetermined positional relationship.

During operation of the inkjet print apparatus 1, the plurality of workpieces W are sequentially conveyed in the direction of the arrow A illustrated in FIG. 1 in a state of being placed on a conveyance surface 10a of the conveyor 10. Therefore, the upstream side in the conveyance direction is the left side in FIG. 1, and the downstream side in the conveyance direction is the right side in FIG. 1. The plurality of workpieces W are placed on the conveyance surface 10a in a state of being spaced apart from each other in the direction of the arrow A which is the conveyance direction. A direction orthogonal to the direction of the arrow A and along the conveyance surface 10a is defined as a width direction.

The workpiece W is not particularly limited, and examples thereof include a packing material for packing various products. As a typical example of the packing material, for example, cardboard and the like can be mentioned. The inkjet print apparatus 1 draws information such as characters including numbers, symbols, bar codes, two-dimensional codes, images, marks, illustrations, combinations thereof, and the like on the workpiece W conveyed by the conveyor 10. In a case where only characters are drawn, the inkjet print apparatus 1 can also be referred to as a printing apparatus or the like, and the drawing machine 2 can also be referred to as a printing machine. Furthermore, the drawing of information by the inkjet print apparatus 1 also includes the case of printing an image or the like. In this case, the inkjet print apparatus 1 can be referred to as a print apparatus. In the following description, character printing and printing are simply referred to as drawing.

Furthermore, an encoder 7 for detecting a position of the workpiece W, a detection sensor 9 to be described later, and the like are connected to the controller 4. The controller 4 detects the position of the workpiece W on the basis of signals output from the encoder 7 and the detection sensor 9. The controller 4 controls the drawing machine 2 so that drawing is started when the workpiece W arrives at a predetermined position.

### Configuration of Drawing Machine 2

The drawing machine 2 is a drop on demand (DOD) type drawing machine that ejects ink only when necessary as a drawing operation, but may be a continuous ink jet (CIJ) type drawing machine that ejects ink even when the drawing operation is not performed, in addition to the DOD type drawing machine. Hereinafter, a case where a DOD type drawing machine is used as the drawing machine 2 of the present embodiment will be described.

As illustrated in FIG. 2, the drawing machine 2 includes an ink supply section 20, a print head drive section 21, and a DOD print head (Hereinafter, referred to as a print head.) 22. The drawing machine 2 also includes a drawing machine body 25 (illustrated in FIG. 1) provided with a print head 22. The drawing machine body 25 is fixed to the conveyor 10 or the like.

The print head 22 is accommodated and fixed inside the drawing machine body 25, and the positional relationship between the drawing machine body 25 and the print head 22 is fixed. Furthermore, the ink supply section 20 and the print head drive section 21 are also accommodated inside the drawing machine body 25.

The print head 22 of the DOD type drawing machine 2 is, for example, a member corresponding to an ejection section, and ejects ink supplied from the detachable cartridge 300 toward the workpiece W conveyed by the conveyor 10. The nozzle groups 22a provided on the front end surface of the print head 22 are arranged in the direction of gravity, that is, the up-down direction. A drawing pattern is formed on the workpiece W by the ink ejected from the nozzle group 22a of the print head 22. There are a plurality of types of structures of the print head 22, and for example, any of a thermal inkjet type, a valve jet type, and a piezo type may be used. In the present embodiment, a piezoelectric print head capable of performing low resolution to high resolution drawing, having a wide drawing width, and having high durability is used as the print head 22. The ink ejected from the print head 22 jumps from the drawing machine body 25 to the outside of the drawing machine body 25 and adheres to the workpiece W.

The ink supply section 20 is a portion that supplies ink to the print head 22, and includes an ink tank 20a that accommodates ink to be supplied to the print head 22, and a cartridge 300 for refilling ink to the ink tank 20a.

The print head drive section 21 is controlled by a control section 40 described later when performing the drawing operation. The print head drive section 21 generates a driving electric waveform for driving the print head 22 and outputs the driving electric waveform to the print head 22. The drive electric waveform is a waveform for individually driving the drive element (piezoelectric vibrator) provided for each ejection port of the print head 22 at a timing based on the drawing command output from the control section 40.

### Configuration of Inspection Machine

The inspection machine 3 is a device that determines whether the drawing state of the drawing pattern drawn on the workpiece W to be drawn is good or bad on the basis of the drawing data by using a captured image acquired by imaging the workpiece W to be drawn, and corresponds to an image inspection section. Furthermore, the inspection machine 3 can also be referred to as an image inspection device. The inspection machine 3 is installed downstream of the drawing machine 2, and can inspect the drawing state of the workpiece W drawn by the drawing machine 2.

The inspection machine 3 includes an illumination section 30, an imaging section 31, a control section 32, and a storage section 33. The illumination section 30 includes, for example, a light emitting diode or the like, and is controlled by the control section 32 to emit light at a predetermined timing to illuminate a drawn portion of the workpiece W. The imaging section 31 is a member for capturing an image of a drawing pattern formed on the workpiece W and generating a captured image. The imaging section 31 includes an optical system 31a including a lens that receives light emitted from the illumination section 30 and reflected from the surface of the workpiece W, an image sensor 31b that receives light emitted from the optical system 31a, and an AF motor 31c. The AF motor 31c is a member for automatically focusing on the drawing portion of the workpiece W by driving a focusing lens of the optical system 31a. The autofocus method is not particularly limited, and examples thereof include a contrast method.

The image sensor 31b includes, for example, a complementary metal oxide semiconductor (CMOS) sensor or the like. The image sensor 31b images the workpiece W to be drawn and generates a captured image. For example, although not illustrated, the light reception amount signal of the light receiving element of the image sensor 31b is output to a field programmable gate array (FPGA) and processed, and is also output to a digital signal processor (DSP) and processed.

The control section 32 includes an imaging setting section 32a. The imaging setting section 32a is a part that sets the imaging setting parameters and reflects the set imaging setting parameters at the time of imaging the workpiece W. The imaging setting parameters include, for example, a plurality of parameters such as timing of illumination by the illumination section 30, brightness (light emission amount), exposure time by the imaging section 31, and focus (focal position) of the imaging section 31. Although not illustrated, the GUI related to the setting of the imaging setting parameters is provided with an area in which brightness of illumination, exposure time, focus, and the like can be individually set. When the user inputs each parameter on the GUI, the imaging setting section 32a accepts a setting operation by the user, outputs each parameter to, for example, the storage section 33, and causes the storage section 33 to store the parameter. Each parameter can be read from the storage section 33 as necessary.

When acquiring the captured image data of the workpiece W, the imaging setting section 32a outputs the imaging setting parameters to the illumination section 30 and the imaging section 31. The illumination section 30 and the imaging section 31 operate according to the imaging setting parameters. Upon receiving the imaging setting parameter, the illumination section 30 sets the received imaging setting parameter in the imaging section 31 so as to reflect the received imaging setting parameter at the time of imaging. Furthermore, when receiving the imaging setting parameter, the imaging section 31 also sets the received imaging setting parameter in the imaging section 31 so as to reflect the received imaging setting parameter at the time of imaging. Upon receiving the imaging trigger, the illumination section 30 and the imaging section 31 illuminate the workpiece W in accordance with the imaging setting parameters and acquire captured image data of the workpiece W by imaging.

The control section 32 may be a part that executes the rule-based image inspection, a part that executes the image inspection using the pre-learned model, or a part that executes both the rule-based image inspection and the image inspection using the pre-learned model as the inspection tool. For example, the control section 32 causes the imaging section 31 to image the workpiece W, acquires captured image data of the workpiece W, and executes an inspection based on a set inspection tool on the acquired captured image of the workpiece W. When executing the inspection, the control section 32 cuts out a range to be inspected from the captured image. The control section 32 extracts a feature amount of the cut inspection range, and determines the extracted characteristic amount by a determination device. In a case where characters are included in the cut out inspection range, the inspection machine 3 can perform character recognition processing, so-called OCR, by using the dictionary when performing character recognition. Furthermore, in a case where a bar code or a two-dimensional code is drawn on the workpiece W, the bar code or the two-dimensional code can be read by the inspection machine 3.

A quality determination section 32b provided in the control section 32 of the inspection machine 3 creates an inspection result by the inspection tool and compares the inspection result with the inspection condition at this time. The inspection condition is acquired from a drawing data generation section 40b of the controller 4. The quality determination section 32b compares, for example, the result of the character recognition processing by the control section 32 with the correct character string acquired from the drawing data generation section 40b, and determines that it is good in a case where they match, and determines that it is defective in a case where they do not match. In the case of a barcode or a two-dimensional code, the reading result of the control section 32 is compared with the code information acquired from the drawing data generation section 40b, and in a case where the reading result matches the code information, it is determined as good, and in a case where the reading result does not match the code information, it is determined as defective.

For example, in a case where there is one set inspection tool, the inspection result related to the set inspection tool is output as it is, but in a case where a plurality of set inspection tools are combined, the inspection result is further generated on the basis of the inspection result of each inspection tool and output from the quality determination section 32b.

### Integral Metal Fitting

As illustrated in FIG. 1, the inkjet print apparatus 1 includes an integral metal fitting 90 for fixing the inspection machine 3 to the drawing machine body 25 that accommodates the print head 22. The integral metal fitting 90 includes a portion to which the drawing machine body 25 is attached and a portion to which the inspection machine 3 is attached. The integral metal fitting 90 has a predetermined dimension in the conveying direction of the workpiece W, and when the inspection machine 3 is fixed to the drawing machine body 25 by the integral metal fitting 90, the inspection machine 3 and the print head 22 can be in a positional relationship of being spaced apart from each other in the conveying direction of the workpiece W, that is, a fixed positional relationship. By fixing the inspection machine 3 to the drawing machine body 25 with the integral metal fitting 90, a relative fixed positional relationship with the print head 22 is defined.

The shape and structure of the integral metal fitting 90 can be arbitrarily set. Furthermore, the length of the integral metal fitting 90 can also be arbitrarily set. The integral metal fitting 90 may be capable of adjusting the length of the workpiece W in the conveying direction. Furthermore, the integral metal fitting 90 may be configured to be able to change a separation distance of the inspection machine 3 from the drawing machine body 25.

The integral metal fitting 90 is detachably attached to the drawing machine body 25 by, for example, a fastening member, and is also detachably attached to the inspection machine 3 by, for example, a fastening member. As a result, the inspection machine 3 can be attached to and detached from the drawing machine body 25.

There may be a plurality of types of the integral metal fittings 90. The integral metal fitting 90 having different dimensions is prepared in advance, and the inspection machine 3 can be fixed to the drawing machine body 25 using the integral metal fitting 90 having an appropriate length according to the user's environment.

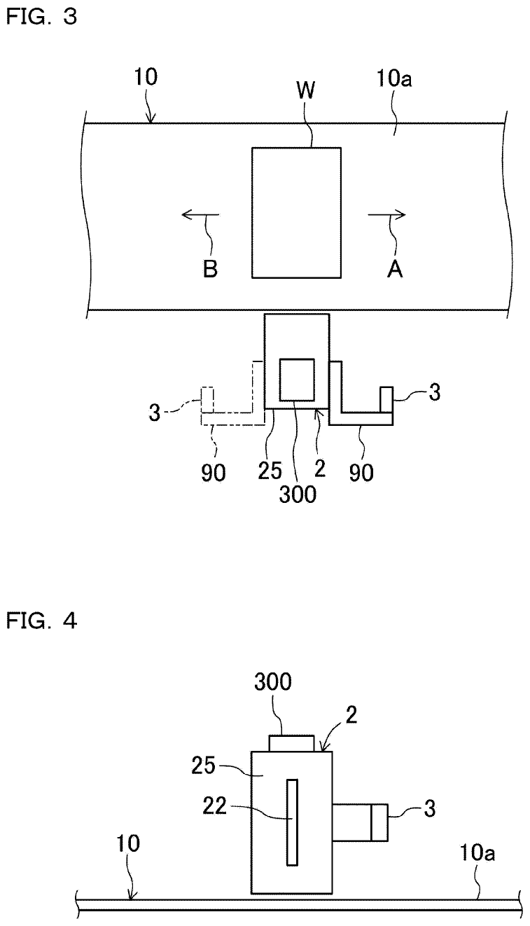

FIG. 3 is a plan view illustrating an installation example of the drawing machine 2 and the inspection machine 3. In a case where the workpiece W is conveyed in the direction of the arrow A, the inspection machine 3 can be installed on the downstream side of the drawing machine 2 in the conveyance direction of the workpiece W by providing the integral metal fitting 90 as indicated by the solid line. On the other hand, in a case where the workpiece W is conveyed in the direction of the arrow B opposite to the direction of the arrow A, the inspection machine 3 can be installed on the downstream side of the drawing machine 2 in the conveyance direction of the workpiece W by providing the integral metal fitting 90 as indicated by a virtual line. In addition, by simultaneously providing the integral metal fitting indicated by a solid line and the integral metal fitting 90 indicated by a virtual line, it is possible to cope with both the direction of arrow A and the direction of arrow B.

FIG. 4 illustrates an installation example of the drawing machine 2 and the inspection machine 3, and is a view (front view) as viewed from a side where ink is ejected. As illustrated in FIG. 4, the inspection machine 3 is fixed to the drawing machine body 25 by the integral metal fitting 90 such that a center of the drawing area in the up-down direction and a center of the field of view of the imaging section 31 of the inspection machine 3 in the up-down direction have the same height.

### Detection Sensor

As illustrated in FIG. 1, the inkjet print apparatus 1 includes the detection sensor 9 that detects arrival of the workpiece W conveyed by the conveyor 10. The detection sensor 9 is installed on the upstream side of the drawing machine 2 in the conveying direction of the workpiece W. The detection sensor 9 is provided with, for example, an optical movement measurement sensor, a distance sensor, and the like (not illustrated), and these sensors can detect arrival of the conveyed workpiece W. When detecting the arrival of the workpiece W, the detection sensor 9 transmits a detection signal to the controller 4. The controller 4 determines that the workpiece W has arrived at a predetermined position on the basis of the detection signal output from the detection sensor 9, and causes the drawing machine 2 to start drawing after a predetermined drawing delay time has elapsed.

### Configuration of Controller 4

As illustrated in FIG. 2, the controller 4 includes a control section 40, a storage section 41, and an operation display section 42. The control section 40 includes, for example, a microcomputer including a central processing section, various memories, and the like, and can execute software stored in advance. The control section 40 is provided with a drawing setting section 40a, the drawing data generation section 40b, an inspection setting section 40c, a display screen generation section 40d, and a mode switching section 40e. The drawing setting section 40a, the drawing data generation section 40b, the inspection setting section 40c, the display screen generation section 40d, and the mode switching section 40e of the control section 40 are parts configured by hardware and software, and are described separately for convenience as the drawing setting section 40a, the drawing data generation section 40b, the inspection setting section 40c, the display screen generation section 40d, and the mode switching section 40e, but may be integrated in hardware.

The operation display section 42 includes a controller-side display section 42a including, for example, a liquid crystal display and a controller-side operation section 42b including operation keys and the like. The controller-side operation section 42b is a part that receives various operations such as drawing contents and settings. Various screens generated by the display screen generation section 40d are displayed on the controller-side display section 42a, and the user can operate the controller-side operation section 42b while viewing the controller-side display section 42a. The operation state of the controller-side operation section 42b can be acquired by the control section 40.

The controller-side operation section 42b may be a touch panel. The touch panel is a member capable of detecting an operation by a user's finger. The type of the touch panel is not particularly limited, and examples thereof include a capacitance type and an infrared type. Operation information of the touch panel by the user is transmitted to the control section 40.

The drawing setting section 40a is a part that sets a drawing content to be drawn on the workpiece W to be drawn. The drawing data generation section 40b is a part that defines ejection of ink in the print head 22 and generates drawing data corresponding to the drawing content set by the drawing setting section 40a. The control section 40 outputs a control signal to the print head drive section 21 on the basis of the drawing data generated by the drawing data generation section 40b, and controls ejection of ink from the ejection port of the print head 22.

The inspection setting section 40c is a part that performs inspection setting by the inspection machine 3. The storage section 41 is a part that stores a relative fixed positional relationship between the inspection machine 3 and the print head 22. The inspection setting section 40c supports the inspection setting by the user on the basis of the drawing content set by the drawing setting section 40a and the relative fixed positional relationship stored in the storage section 41.

### Detailed Structure of Drawing Machine

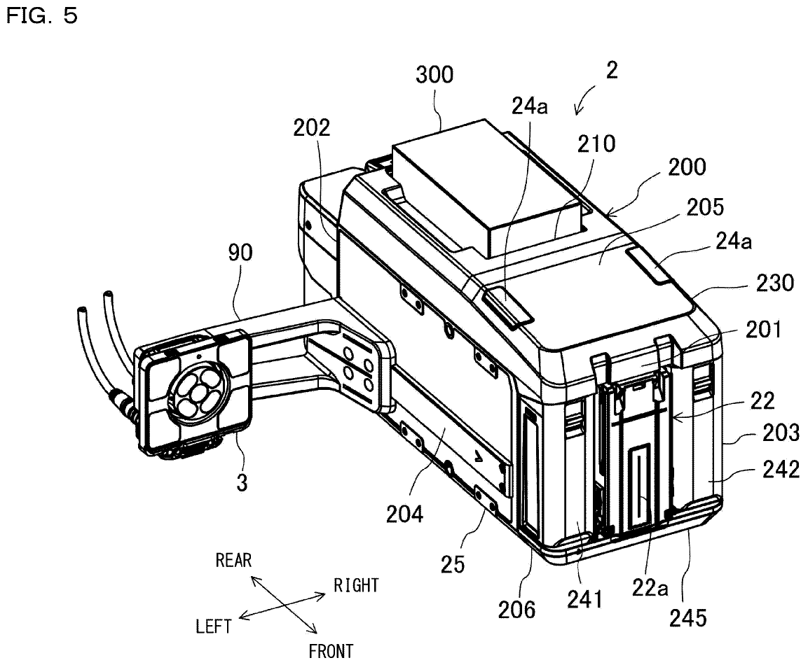

FIGS. 1 to 4 schematically illustrate the shapes of the drawing machine 2, the print head 22, the drawing machine body 25, the cartridge 300, and the like, but specific shapes of the drawing machine 2, the print head 22, the drawing machine body 25, the cartridge 300, and the like are as illustrated in each of FIG. 5 and subsequent drawings. The shapes illustrated in FIG. 5 and subsequent drawings and the shapes illustrated in FIGS. 1 to 4 may be partially different from each other, but the reason is that FIGS. 1 to 4 are drawings for conceptual description.

As illustrated in FIG. 5, the drawing machine body 25 includes a box-shaped housing 200 extending in the longitudinal direction. The ink tank 20a illustrated in FIG. 2 is provided inside the housing 200, and cannot be visually recognized from the outside. In the installation state of the drawing machine 2, the longitudinal direction of the housing 200 coincides with the width direction of the conveyor 10. In the present specification, a longitudinal direction of the housing 200 is defined as a front-rear direction, and a side facing the workpiece W at the time of installation is defined as a front side. Furthermore, a side located on the right when the drawing machine 2 is viewed from the front side is defined as the right side, a side located on the left when the drawing machine 2 is viewed from the front side is defined as the left side, and the left-right direction of the drawing machine 2 is defined as the width direction. The definition of the direction is a definition for convenience of description, and does not limit the direction according to the present invention.

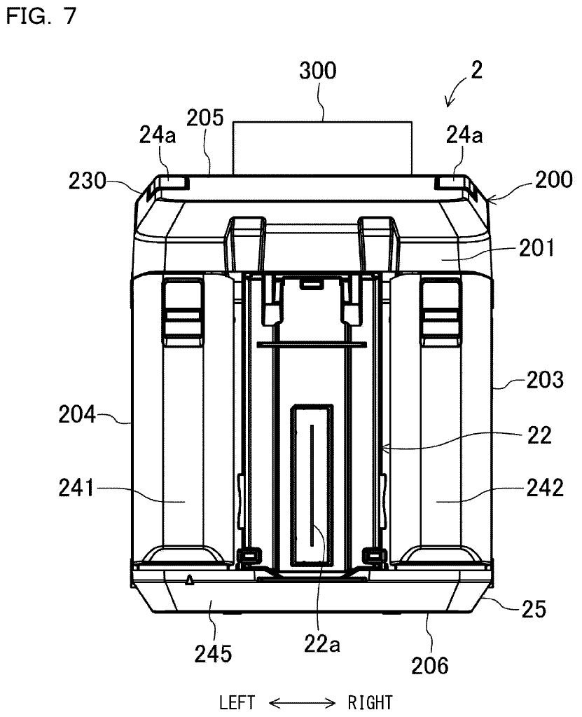

As illustrated in FIGS. 5 to 9, the housing 200 has a shape close to a rectangular parallelepiped that is long in the front-rear direction. Therefore, the dimension of the housing 200 in the front-rear direction is longer than the dimension of the housing 200 in the left-right direction and the dimension of the housing 200 in the up-down direction.

Since the housing 200 has a shape close to a rectangular parallelepiped, the outer peripheral surface of the housing 200 includes six surfaces. That is, the outer peripheral surface of the housing 200 includes a front surface 201 disposed to face the workpiece W, a rear surface 202 located on the opposite side of the front surface 201, a right side surface 203 located on the right when viewed from the direction facing the front surface 201, a left side surface 204 located on the left when viewed from the direction facing the front surface 201, an upper surface 205, and a lower surface 206. The front surface 201, the rear surface 202, the right side surface 203, and the left side surface 204 are surfaces constituting an outer side surface of the housing 200. One end face in the longitudinal direction of the outer side face of the housing 200 is a front surface 201, and the other end face in the longitudinal direction of the outer side face of the housing 200 is a rear surface 202. The front surface 201 is provided with a print head 22 for ejecting ink toward the workpiece W being conveyed. Note that the front surface 201 may be referred to as a front surface or a back surface of the rear surface 202.

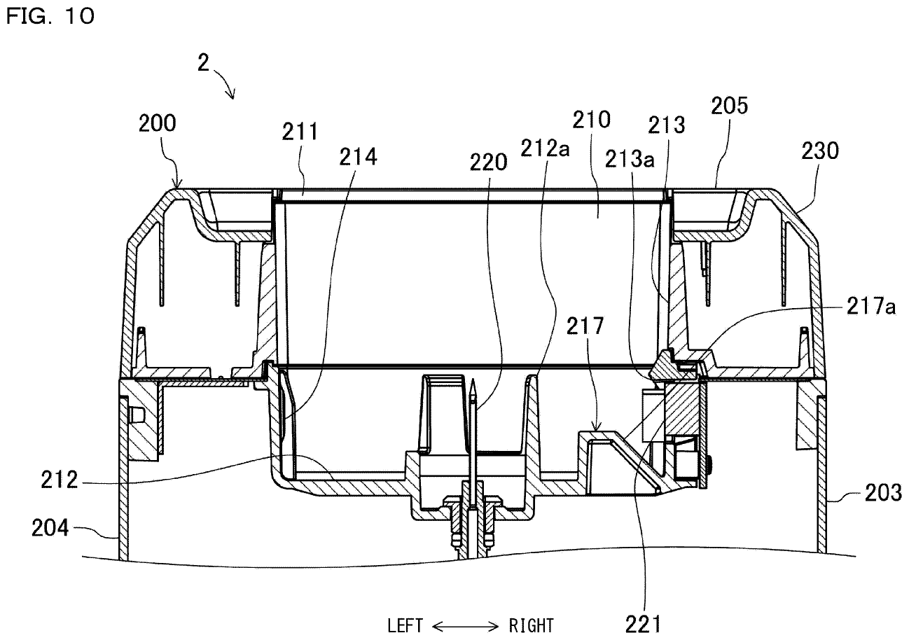

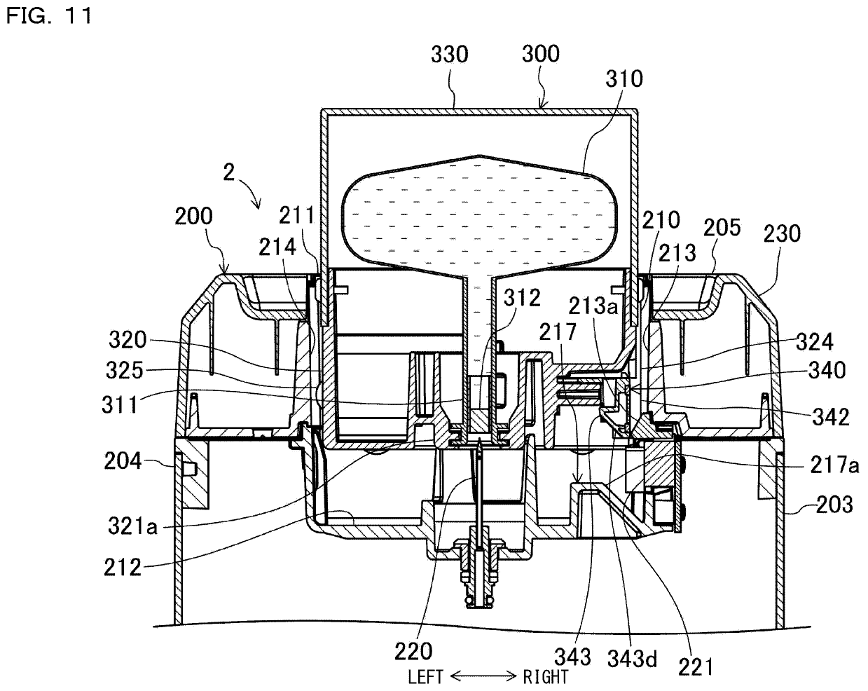

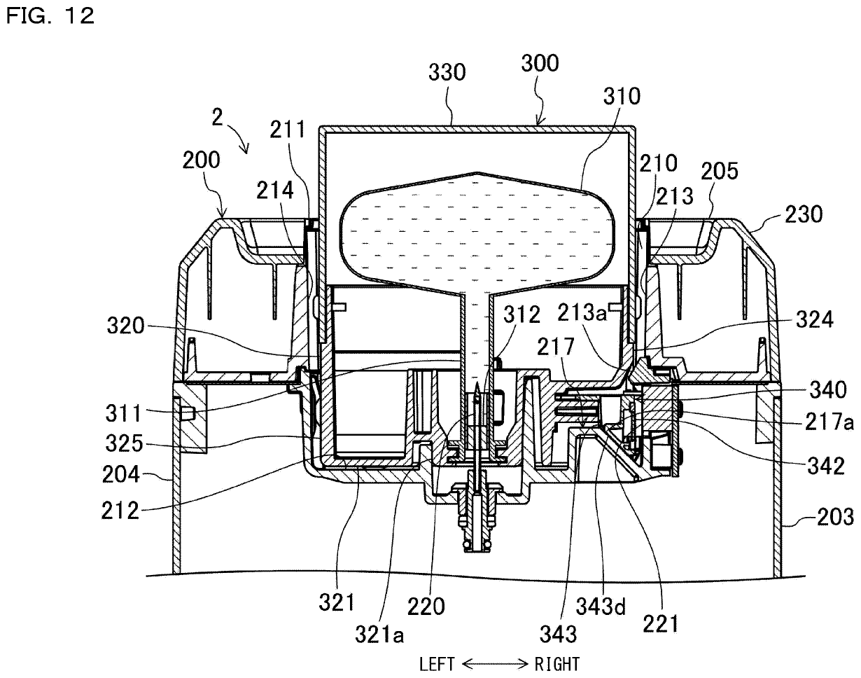

As also illustrated in FIGS. 10 to 12, a cartridge receiving section 210 that receives the cartridge 300 is provided on the upper surface 205 of the housing 200. FIG. 10 illustrates a state before the cartridge 300 is received, FIG. 11 illustrates a state in the middle of receiving the cartridge 300, and FIG. 12 illustrates a state in which the cartridge 300 is completely received, that is, a state in which the cartridge 300 is attached to the drawing machine body 25.

Note that, in the present embodiment, a case where the cartridge receiving section 210 is provided on the upper surface 205 of the housing 200 will be described, but the present invention is not limited thereto. Although not illustrated, the cartridge receiving section may be provided on any one of the outer surface excluding the front surface 201 of the housing 200, that is, the rear surface 202, the right side surface 203, and the left side surface 204. For example, in a case where the cartridge receiving section is provided on the rear surface 202, the reception port may be opened to the rear surface 202. In a case where the cartridge receiving section is provided on the right side surface 203, the reception port may be opened to the right side surface 203. In a case where the cartridge receiving section is provided on the left side surface 204, the reception port may be opened to the left side surface 204. Hereinafter, the cartridge receiving section 210 provided on the upper surface 205 of the housing 200 will be described.

The cartridge receiving section 210 is formed to be long in the longitudinal direction of the housing 200. The cartridge receiving section 210 includes a reception port 211 that opens on the upper surface 205 of the housing 200 and receives the cartridge 300 from above, and a bottom surface 212 with which a lower surface, which is a surface on a mouth (described later) side of the cartridge 300, abuts when the cartridge 300 is received from the reception port 211. In other words, the bottom surface 212 of the cartridge receiving section 210 is a surface facing a lower surface which is a surface on a mouth (described later) side of the cartridge 300 when the cartridge 300 is received from the reception port 211. Since the reception port 211 is opened upward, a receiving direction of the cartridge 300 is a direction from the top to the bottom.

The reception port 211 and the bottom surface 212 of the cartridge receiving section 210 have a substantially rectangular shape elongated in the longitudinal direction (front-rear direction) of the housing 200. The dimension in the longitudinal direction and the dimension in the lateral direction (left-right direction) of the cartridge receiving section 210 are longer than the dimension in the receiving direction of the cartridge 300 in the cartridge receiving section 210. Therefore, the dimension of the short side of the bottom surface 212 is longer than the dimension in the receiving direction of the cartridge 300 in the cartridge receiving section 210. When the housing 200 is viewed from above in a state where the cartridge 300 is not mounted, substantially the entire bottom surface 212 can be visually recognized through the reception port 211.

As described above, the dimension of the long side of the rectangle, which is the width dimension of the bottom surface 212 of the cartridge receiving section 210 having a substantially rectangular shape, is longer than the dimension in the receiving direction of the cartridge 300. The bottom surface of the cartridge receiving section 210 may have a substantially square shape, a substantially circular shape, or a substantially elliptical shape, and the dimensions of one side of the square, the diameter of the circle, and the major axis of the ellipse, which are the respective width dimensions, are longer than the dimensions in the receiving direction of the cartridge 300 in the cartridge receiving section 210.

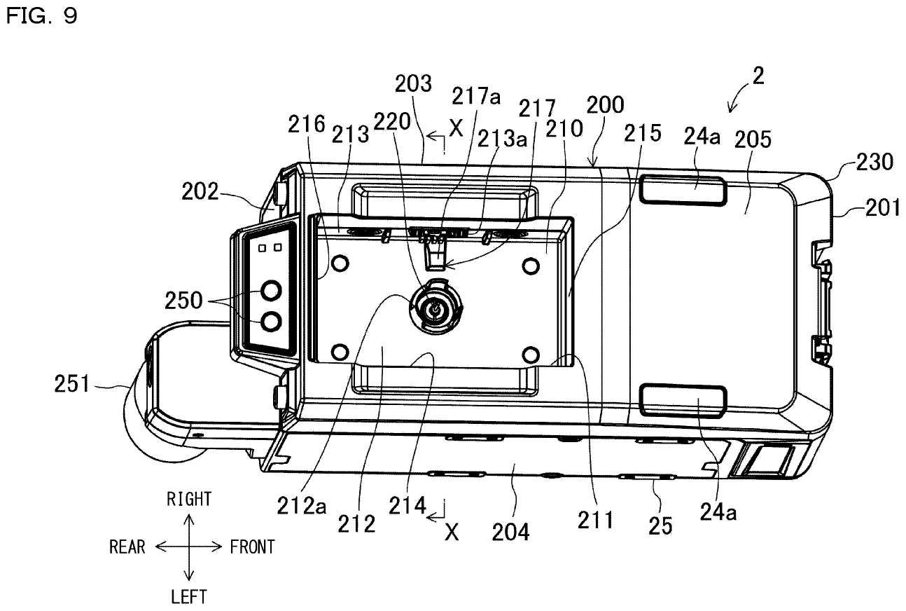

As illustrated in FIG. 9, the cartridge receiving section 210 includes a right inner surface 213, a left inner surface 214, a front inner surface 215, and a rear inner surface 216 in addition to the bottom surface 212. The right inner side surface 213 is a side surface extending upward from the right edge of the bottom surface 212 toward the reception port 211. The left inner surface 214 is a side surface extending upward from a left edge of the bottom surface 212 toward the reception port 211. The front inner surface 215 is a side surface extending upward from a front edge of the bottom surface 212 toward the reception port 211. The rear inner side surface 216 is a side surface extending upward from a rear edge of the bottom surface 212 toward the reception port 211. Therefore, the right inner surface 213 and the left inner surface 214 face each other, and the front inner surface 215 and the rear inner surface 216 face each other.

The dimension in the front-rear direction of the right inner surface 213 and the left inner surface 214 corresponds to the dimension of the long side of the bottom surface 212, and the dimension in the left-right direction of the front inner surface 215 and the rear inner surface 216 corresponds to the dimension of the short side of the bottom surface 212. Therefore, the dimension in the front-rear direction of the right inner surface 213 and the left inner surface 214 is longer than the dimension in the left-right direction of the front inner surface 215 and the rear inner surface 216.

The drawing machine body 25 includes a hollow needle 220. The hollow needle 220 is provided to protrude from the bottom surface 212 of the cartridge receiving section 210 toward the reception port 211, and is a member for sucking out ink from the cartridge 300 through a rubber plug 312 (described later) of the cartridge 300 when the cartridge 300 is received in the cartridge receiving section 210. A lower portion of the hollow needle 220 is held by the bottom surface 212 of the cartridge receiving section 210. A lower end portion of the hollow needle 220 is connected to the ink tank 20a via an ink pipe (not illustrated). Therefore, the ink accommodated in the cartridge 300 flows through the hollow needle 220, then flows through the ink pipe, and then is stored in the ink tank 20a.

A bottom surface 212 of the cartridge receiving section 210 is provided with a standing wall portion 212a around the hollow needle 220. A plurality of the standing wall portions 212a are provided at intervals in the circumferential direction of the hollow needle 220. The standing wall portion 212a enables protection of the hollow needle 220. Furthermore, when the cartridge 300 is received, the mouth 311 can be guided to a predetermined position by the standing wall portion 212a.

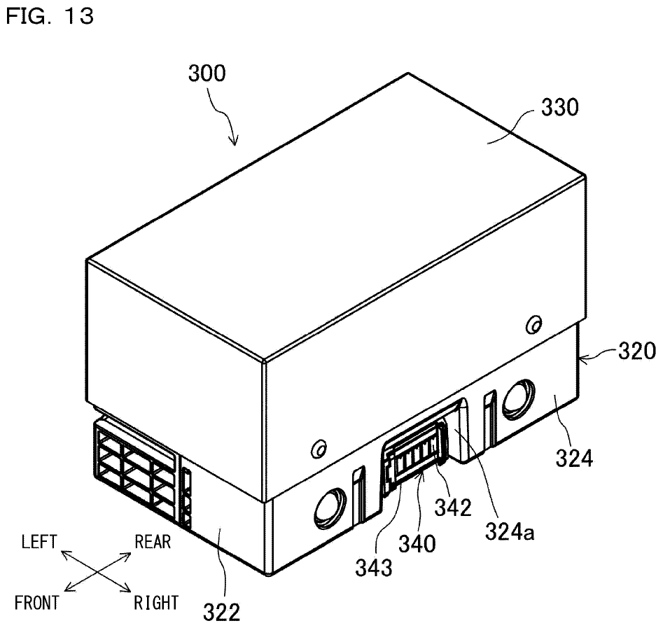

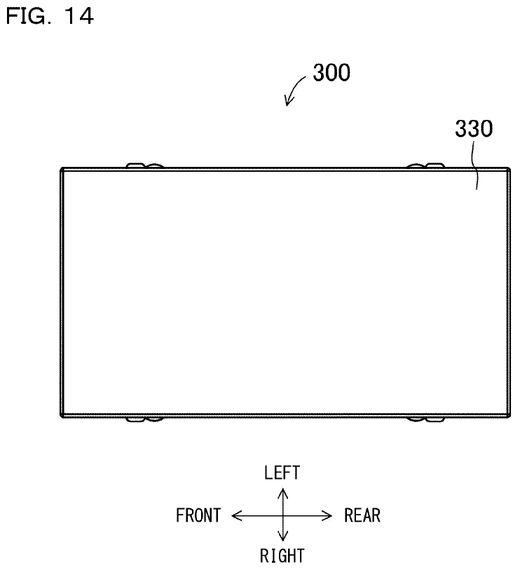

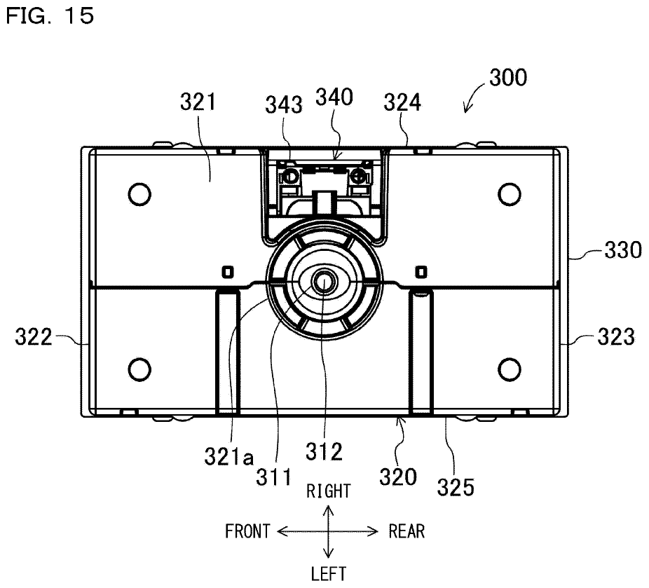

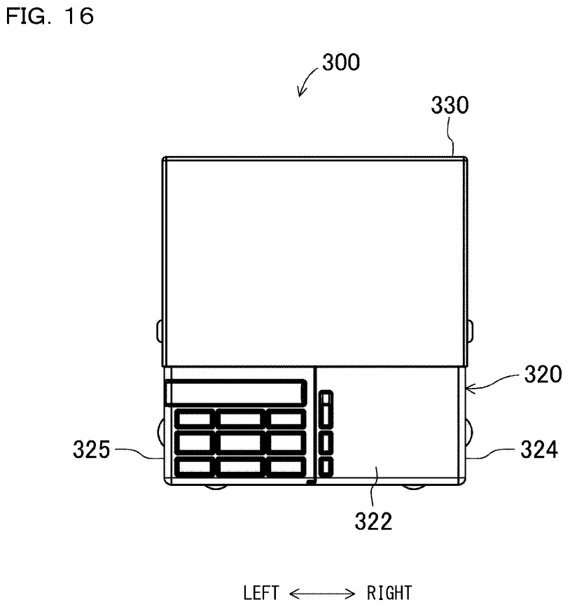

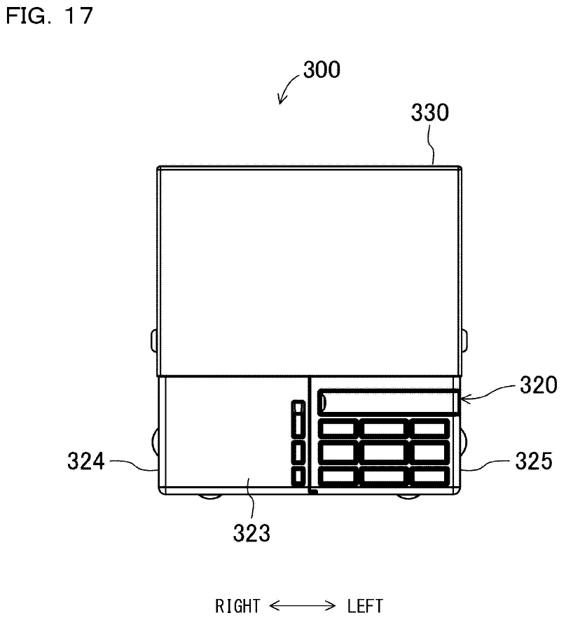

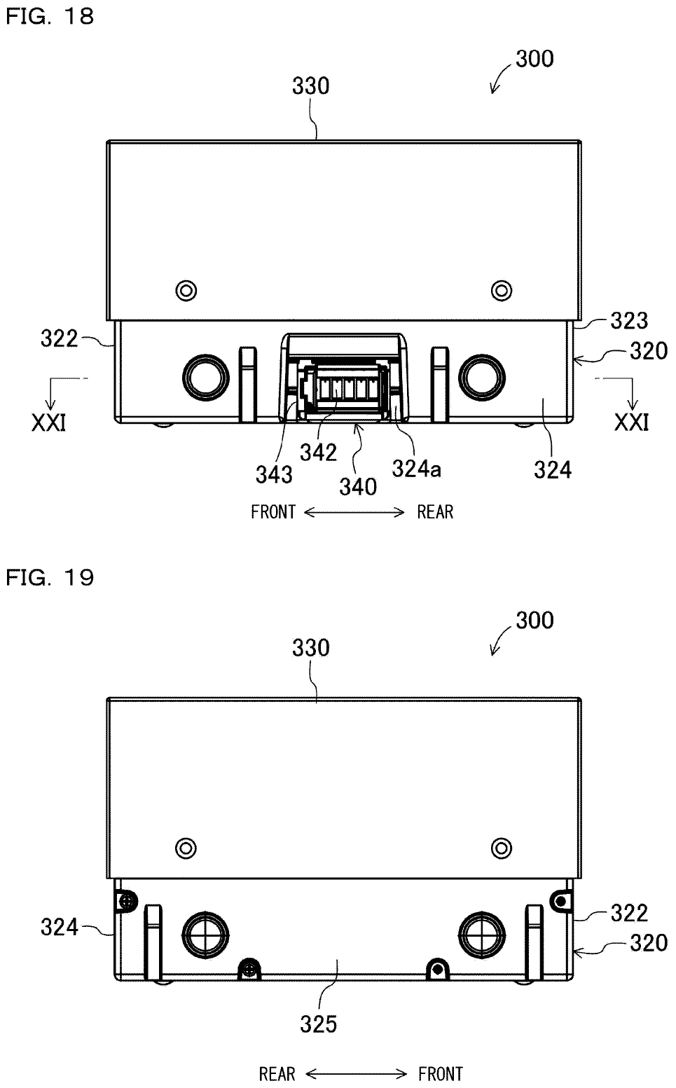

FIGS. 13 to 19 are diagrams illustrating the appearance of the cartridge 300. A cross-section of the cartridge 300 is illustrated in FIGS. 11 and 12. The cartridge 300 has a shape elongated in the longitudinal direction of the cartridge receiving section 210 of the housing 200. In a state where the cartridge 300 is received in the cartridge receiving section 210, an upper portion of the cartridge 300 protrudes upward from the upper surface 205 of the housing 200. As described above, the entire cartridge 300 is not accommodated in the housing 200, but only the lower portion of the cartridge 300 is accommodated in the cartridge receiving section 210 of the housing 200. A portion of the cartridge 300 that is not accommodated in the cartridge receiving section 210 is exposed to the outside of the housing 200. In this embodiment, since the cartridge 300 protrudes upward from the upper surface 205 of the housing 200, it is possible to increase the capacity of the cartridge 300 and dispose a part thereof outside the housing 200 without affecting a member installed on the side of the housing 200, a member installed behind the housing 200, or the like.

Note that the cartridge 300 may accommodate a device cleaning liquid in addition to the case where the ink is accommodated. The present invention is applicable to any case.

As illustrated in FIGS. 11 and 12, the cartridge 300 includes a pouch 310 as an ink accommodation section that accommodates ink, an outer case 320 that accommodates at least a part of the pouch 310, and an exterior material 330. The pouch 310 is a bag-like member in which ink is sealed together with air (an example of gas), and is formed of a film or a sheet-like member having flexibility. By enclosing a small amount of air in the pouch 310, the ink in the pouch 310 can be sucked out to the end. Furthermore, by providing a plate or the like in the pouch 310 so as not to block the vicinity of the suction port, the ink in the pouch 310 can be sucked out to the end. By the ratio between the longitudinal dimension and the lateral dimension of the pouch 310, it is possible to control how the pouch 310 is crushed when the ink decreases.

The material, structure, and the like of the member constituting the pouch 310 are not particularly limited as long as the member has resistance to ink, but for example, a member in which a resin layer and an aluminum layer are laminated can be used.

The pouch 310 has a shape elongated in the front-rear direction. Furthermore, the pouch 310 is a gusset type pouch having a gusset. Each dimension of the pouch 310 is set to a length that can secure the maximum internal volume while being capable of being accommodated in the outer case 320 and the exterior material 330. Note that the ink accommodation section may be formed of a member other than the pouch 310, for example, a hard resin container. Furthermore, the exterior material 330 may be provided as necessary, and may be omitted. The shape of the ink accommodation section may also be a shape other than the shape elongated in the front-rear direction, for example, a bottle shape having a neck portion.

A mouth 311 is provided in a lower portion of the pouch 310. The mouth 311 includes a conduit member made of a hard resin material or the like having higher rigidity than the member constituting the pouch 310 and extending in the up-down direction. A flow path communicating with the internal space of the pouch 310 is formed inside the mouth 311. The mouth 311 is provided with a rubber plug 312 for sealing the flow path. Since the rubber plug 312 is provided, the ink does not leak from the mouth 311 when the cartridge 300 is transported or stored. On the other hand, when the cartridge 300 is received in the cartridge receiving section 210, the hollow needle 220 penetrates the rubber plug 312, and a distal end portion of the hollow needle 220 reaches the flow path above the rubber plug 312. Thus, the ink can flow into the hollow needle 220. In other words, the outer case 320 supports the mouth 311 by exposing the rubber plug 312 to the outside so that the ink accommodated in the pouch 310 can be accessed from the outside. The outer case 320 positions and supports the mouth 311 with respect to the bottom wall portion 321 such that the hollow needle 220 comes into contact with the rubber plug 312 in a case where the cartridge 300 is received in the cartridge receiving section 210. In a state where the hollow needle 220 penetrates the rubber plug 312, the rubber plug 312 is brought into close contact with the outer peripheral surface of the hollow needle 220, so that leakage of ink is suppressed. When the hollow needle 220 is detached from the rubber plug 312 when the cartridge 300 is detached from the cartridge receiving section 210, the hole into which the hollow needle 220 has been inserted is blocked, and the leakage of ink is suppressed. Since the rubber plug 312 is adopted, the force required for piercing or pulling out the hollow needle 220 can be small.

The outer case 320 is made of a hard resin material or the like having higher rigidity than the member constituting the pouch 310, and has a shape elongated in the front-rear direction. That is, the outer case 320 includes a bottom wall portion 321 having a shape elongated in the front-rear direction, a front side wall portion 322, a rear side wall portion 323, a right side wall portion 324, and a left side wall portion 325. The front side wall portion 322 rises from a front edge (edge extending in the lateral direction) of the bottom wall portion 321 and extends upward. The rear side wall portion 323 rises from a rear edge (edge extending in the lateral direction) of the bottom wall portion 321 and extends upward. The right side wall portion 324 rises from a right edge (edge extending in the longitudinal direction) of the bottom wall portion 321 and extends upward. The left side wall portion 325 rises from a left edge (edge extending in the longitudinal direction) of the bottom wall portion 321 and extends upward. Therefore, the front side wall portion 322 and the rear side wall portion 323 face each other, and the right side wall portion 324 and the left side wall portion 325 face each other.

The outer case 320 is opened upward, and the pouch 310 can be accommodated in the outer case 320 from the opened portion. An annular protrusion 321a is formed at an intermediate portion in the longitudinal direction and an intermediate portion in the lateral direction of the bottom wall portion 321 of the outer case 320. The lower portion of the mouth 311 is held in a state of being fitted inside the annular protrusion 321a. Therefore, the mouth 311 is held at an intermediate portion in the longitudinal direction and an intermediate portion in the lateral direction of the bottom wall portion 321. In other words, the annular protrusion 321a formed on the bottom wall portion 321 of the outer case 320 holds one end of the mouth 311 to be exposed to the outside. Note that the term “exposed to the outside” means that one end of the mouth 311 of the outer case does not need to protrude with respect to the bottom wall portion 321, and may be recessed with respect to the bottom wall portion 321. It is sufficient that the hollow needle 220 included in the cartridge receiving section 210 penetrates the rubber plug 312 of the cartridge 300 and the ink accommodated in the pouch 310 can be accessed from the outside so that the distal end portion of the hollow needle 220 can reach the flow path above the rubber plug 312.

The exterior material 330 is a member that is opened downward and serves as a lid of the outer case 320, and is made of, for example, cardboard, a resin material, or the like. The pouch 310 can be protected by covering the pouch 310 with the exterior material 330 from above. On the outer surface of the exterior material 330, for example, a display area in which information regarding ink and the like are displayed is provided.

In a case where the capacity of the ink is increased, for example, a method of coping with the increase in size of the pouch 310 can be considered. In this case, since the outer case 320 has a size that can be received in the cartridge receiving section 210 of the housing 200, the outer case 320 cannot be enlarged in the front-rear direction and the left-right direction. Therefore, it is necessary to increase the capacity by increasing the height of the pouch 310.

In the present embodiment, since the exterior material 330 is separated from the outer case 320, when the height of the pouch 310 is increased, the exterior material 330 can be changed to a high one without changing the outer case 320. That is, in the case of further increasing the capacity of the cartridge 300 as compared with the illustrated cartridge 300, even if the size of the cartridge 300 in the up-down direction is increased, only the exterior material 330 which is the upper portion of the cartridge largely protrudes from the cartridge receiving section 210, it is not necessary to change the outer case 320 and the housing 200, and the increase in the capacity of the cartridge 300 does not affect the side and the rear of the housing 200.

As illustrated in FIGS. 13, 15, 18, and the like, a movable ROM unit 340 is provided on the right side wall portion 324 of the cartridge 300. A recess 324a in which the ROM unit 340 is accommodated is formed at an intermediate portion of the right side wall portion 324 in the front-rear direction. The ROM unit 340 is disposed above the bottom surface 212 of the cartridge receiving section 210, thereby suppressing the ink from adhering to the ROM unit 340.

FIG. 20 is a diagram illustrating a single ROM unit 340, and the ROM unit 340 includes a recording medium 341 that records information regarding the cartridge 300, an access terminal 342 electrically connected to the recording medium 341, and a holding member 343 that holds the recording medium 341 and the access terminal 342. The recording medium 341 may be configured by a read-only memory, that is, a read only memory (ROM), or may be configured by a memory capable of reading and writing, that is, a random access memory (RAM) in a case of updating information regarding the cartridge 300. In a case where the RAM is used, the RAM unit can be referred to as a RAM unit. Examples of the information recorded on the recording medium 341 include the type and remaining amount of ink sealed in the pouch 310.

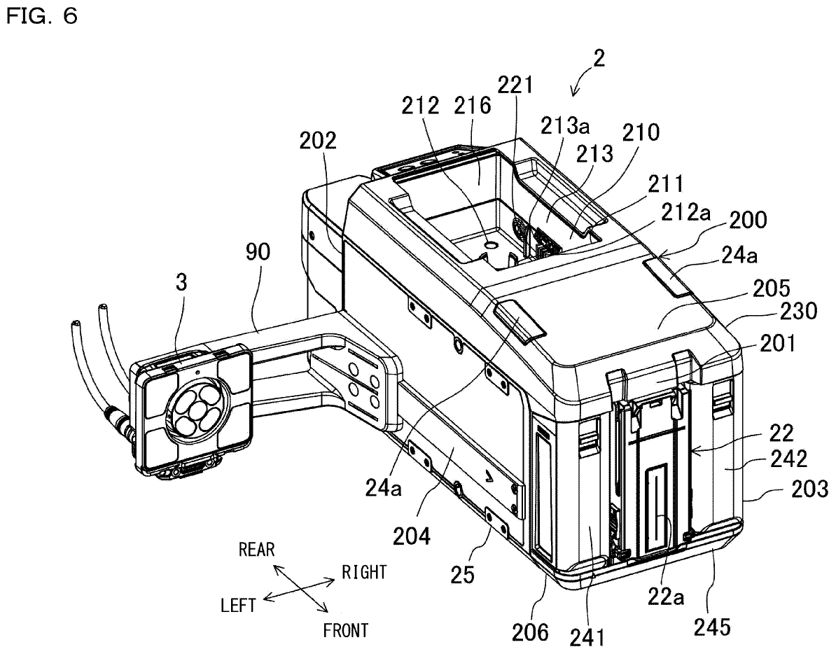

The access terminal 342 is a terminal accessed from a body-side terminal 221 (FIG. 6, FIG. 11, and FIG. 12) on the drawing machine 2 side via the cartridge receiving section 210. The body-side terminal 221 is a member that comes into contact with the access terminal 342 in a state where the cartridge 300 is received in the cartridge receiving section 210 and constitutes a part of the communication path.

As illustrated in FIG. 2, the drawing machine body 25 is provided with a recording medium management section 23 that communicates with the recording medium 341 via a communication path including the access terminal 342 and the body-side terminal 221. The recording medium management section 23 is a unit that controls the drawing machine 2 on the basis of the information acquired from the recording medium 341 and transmits the information acquired from the recording medium 341 to the controller 4.

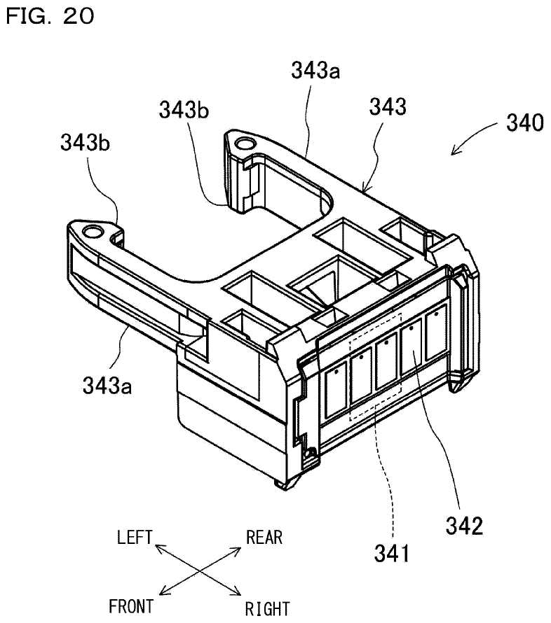

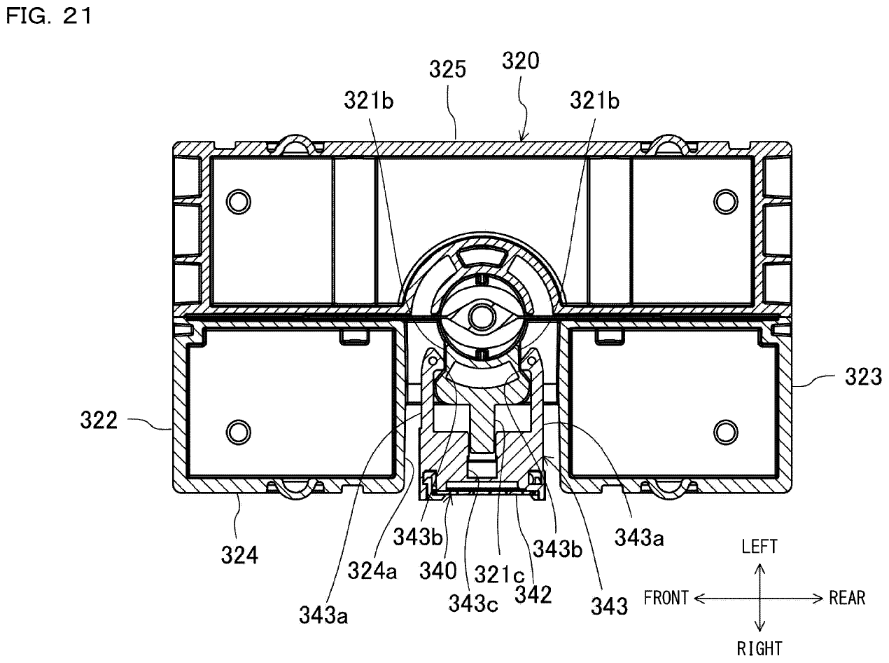

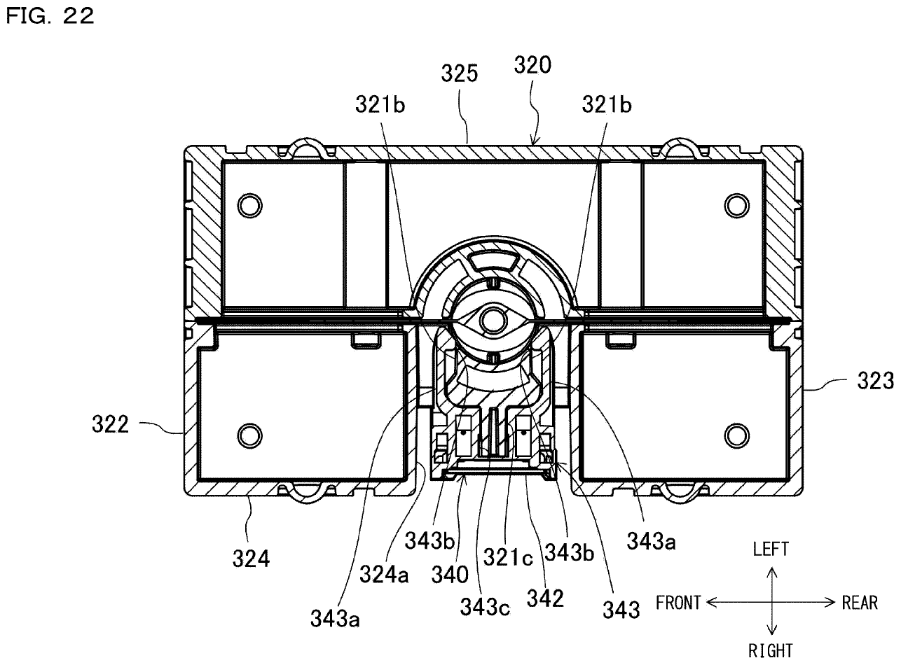

The holding member 343 is supported by the outer case 320 so as to be switchable between an advanced position (illustrated in FIGS. 12 and 21) where the access terminal 342 comes into contact with the body-side terminal 221 and a retracted position (illustrated in FIGS. 11 and 22) where the access terminal 342 is separated from the body-side terminal 221 by sliding in a direction (left-right direction) orthogonal to the right side wall portion 324 of the outer case 320. The holding member 343 may be attached to the outer case 320 and directly supported by the outer case 320, or may be attached to another member supported by the outer case 320 and indirectly supported by the outer case 320.

Specifically, the holding member 343 includes a pair of arms 343a provided at intervals in the front-rear direction. Each arm 343a extends in the left direction, and a projection 343b protruding in a direction approaching each other is formed at the distal end portion. On the other hand, as illustrated in FIGS. 21 and 22, on the bottom wall portion 321 of the outer case 320, a pair of guide surfaces 321b extending in the left-right direction are formed at intervals in the front-rear direction. The projection 343b located on the front side of the holding member 343 is guided in the left-right direction by the guide surface 321b by sliding in the left-right direction on the guide surface 321b located on the front side. Furthermore, the projection 343b located on the rear side of the holding member 343 is guided in the left-right direction by the guide surface 321b by sliding the guide surface 321b located on the rear side in the left-right direction. Therefore, each guide surface 321b is a guide portion that guides the holding member 343 in a direction orthogonal to the right side wall portion 324 of the outer case 320.

Furthermore, the bottom wall portion 321 of the outer case 320 is formed with a side protrusion 321c protruding rightward. On the other hand, the holding member 343 is formed with a guide groove 321c into which the side protrusion 343c is inserted. The side protrusion 321c is guided in a direction orthogonal to the right side wall portion 324 of the outer case 320 in a state of being inserted into the guide groove 343c. Therefore, the guide groove 343c also functions as a guide portion. The holding member 343 is attached to the bottom wall portion 321 in a state where the movement in the up-down direction and the front-rear direction is restricted so that the holding member moves while being guided in the left-right direction by the guide portion, but hardly moves in the up-down direction and the front-rear direction.

As illustrated in FIG. 6, the body-side terminal 221 is provided on the right inner surface 213 of the cartridge receiving section 210 and protrudes inward (leftward) of the cartridge receiving section 210. The height of the body-side terminal 221 is the same as the height of the access terminal 342 of the cartridge 300 in a state of being received in the cartridge receiving section 210. Furthermore, the position of the body-side terminal 221 in the front-rear direction is the same as the position of the access terminal 342 of the cartridge 300 in the front-rear direction in a state of being received by the cartridge receiving section 210. As a result, when the cartridge 300 is received in the cartridge receiving section 210, the body-side terminal 221 comes into contact with the access terminal 342 and becomes conductive.

The body-side terminal 221 is constantly urged toward the inside of the cartridge receiving section 210 by an urging member (not illustrated). In a state where the body-side terminal 221 is not in contact with the access terminal 342, the body-side terminal is positioned inside the cartridge receiving section 210 from a contact position with the access terminal 342. When coming into contact with the access terminal 342, the body-side terminal 221 is pressed rightward by the access terminal 342, thereby moving rightward against the biasing force of the biasing member. Since the body-side terminal 221 is in contact with the access terminal 342 in this state, even if the relative positional relationship between the body-side terminal 221 and the access terminal 342 in the left-right direction changes due to a manufacturing error or the like, the body-side terminal 221 can be reliably pressed against the access terminal 342 to be conducted.

On the right inner side surface 213 of the cartridge receiving section 210, a canopy 213a that suppresses contamination of the body-side terminal 221 is formed on the reception port 211 side (upper side) with respect to the body-side terminal 221. The canopy 213a protrudes from the right inner side surface 213 toward the inside of the cartridge receiving section 210 and has a predetermined width in the front-rear direction. When the cartridge receiving section 210 is viewed from directly above, the body-side terminal 221 is disposed at a position hidden by the canopy 213a. As a result, dust, members, ink, and the like falling from above are less likely to come into contact with the body-side terminal 221, and the body-side terminal 221 can be protected.

It is conceivable that while the body-side terminal 221 can be protected by providing the canopy 213a, the access terminal 342 comes into contact with the canopy 213a in the middle of receiving the cartridge 300 in the cartridge receiving section 210, and it becomes difficult to receive the cartridge 300. On the other hand, in the present embodiment, the holding member 343 holding the recording medium 341 and the access terminal 342 can be moved from the advanced position to the retracted position, and the switching section 217 for switching the holding member 343 in the retracted position to the advanced position is formed on the bottom surface 212 of the cartridge receiving section 210 at a stage where the access terminal 342 is closer to the bottom surface 212 than the canopy 213a in the process of receiving the cartridge 300.

As illustrated in FIG. 10, the switching section 217 protrudes upward from the bottom surface 212 of the cartridge receiving section 210, and is positioned between the hollow needle 220 and the body-side terminal 221. The switching portion 217 has a main-body-side inclined surface 217a that is inclined downward so as to be positioned downward toward the right side. On the other hand, on the lower surface of the holding member 343d, a cartridge-side inclined surface 343d is formed at a position corresponding to a body-side inclined surface 217a. Like the body-side inclined surface 217a, the cartridge-side inclined surface 343d is also inclined downward so as to be positioned downward toward the right side.

When the cartridge-side inclined surface 343d comes into contact with the body-side inclined surface 217a and slides, the holding member 343 can be moved in the left-right direction with respect to the bottom wall portion 321 of the outer case 320 to switch from the retracted position to the advanced position. The timing at which the holding member 343 is switched from the retracted position to the advanced position, the moving speed at the time of switching from the retracted position to the advanced position, and the moving amount of the holding member 343 can be arbitrarily changed depending on the positions in the height direction of the body-side inclined surface 217a and the cartridge-side inclined surface 343d, the inclination angle, and the like.

In this embodiment, as illustrated in FIGS. 11 and 12, the holding member 343 is switched from the retracted position to the advanced position while the cartridge 300 is moved from the upper side to the lower side of the cartridge receiving section 210 and completely attached to the cartridge receiving section 210. Specifically, the heights of the cartridge-side inclined surface 343d and the body-side inclined surface 217a are set so as to remain at the retracted position until the holding member 343 reaches below the canopy 213a beyond the canopy 213a in the middle of moving the cartridge 300 downward. Accordingly, interference between the holding member 343 and the canopy 213a is avoided.

When the cartridge 300 further moves downward and the holding member 343 reaches below the canopy 213a, the cartridge-side inclined surface 343d comes into contact with the body-side inclined surface 217a and slides in the right direction, so that the holding member 343 moves in the right direction, that is, to the advanced position. Then, when the cartridge 300 moves further downward and is completely received in the cartridge receiving section 210, the holding member 343 is switched to the advanced position, and the access terminal 342 comes into contact with the body-side terminal 221.

The timing at which the hollow needle 220 penetrates the rubber plug 312 of the pouch 310 is set to a timing before the access terminal 342 comes into contact with the body-side terminal 221. That is, the timing at which the hollow needle 220 penetrates the rubber plug 312 can be arbitrarily changed according to a protrusion height of the hollow needle 220, a height of the rubber plug 312, and the like. In this embodiment, when the holding member 343 is in the retracted position, the hollow needle 220 starts to pierce the rubber plug 312, and the hollow needle 220 penetrates the rubber plug 312 before the holding member 343 is switched to the advanced position. That is, the timing of each connection is set such that the electrical connection by the access terminal 342 and the body-side terminal 221 is performed after the fluid connection by the hollow needle 220 is completed.

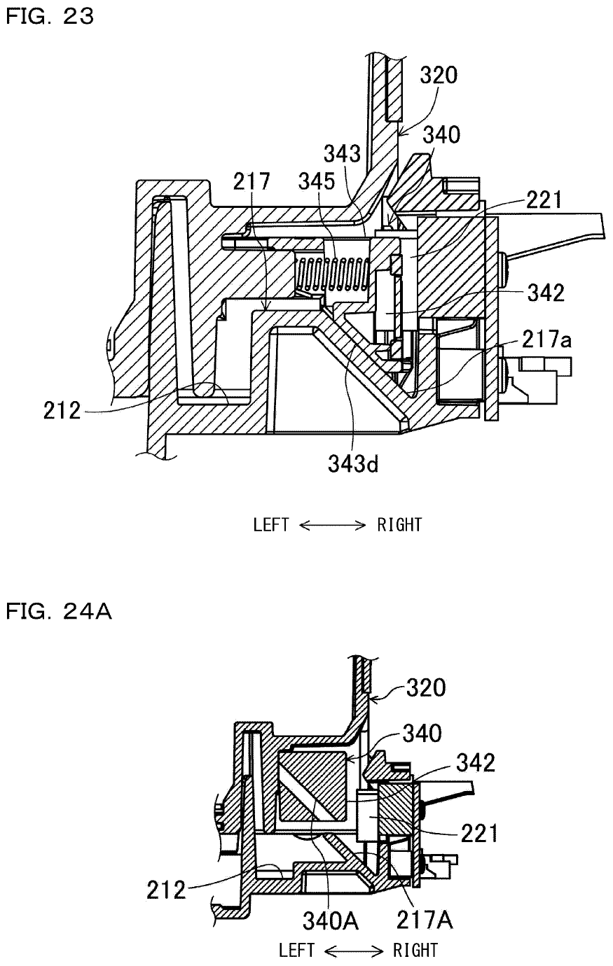

FIG. 23 is a cross-sectional view of the periphery of a ROM unit 340 and a switching section 217 according to Modification 1 of the embodiment of the present invention. In this Modification 1, a spring 345 is provided which causes a biasing force for biasing the holding member 343 toward the advanced position to act on the holding member 343. The extending and contracting direction of the spring 345 is a moving direction of the holding member 343. The spring 345 is disposed between the holding member 343 and the bottom wall portion 321 of the outer case 320. In Modification 1, the holding member 343 is inserted into the cartridge receiving section 210 in a state where the holding member 343 is at the advanced position. However, when the holding member hits the canopy 213a in the middle of the insertion, the holding member is pressed in the retreating direction by the canopy 213a, so that the holding member is switched to the retracted position. When exceeding the canopy 213a, the holding member 343 is switched to the advanced position. Rubber or the like may be used instead of the spring 345.

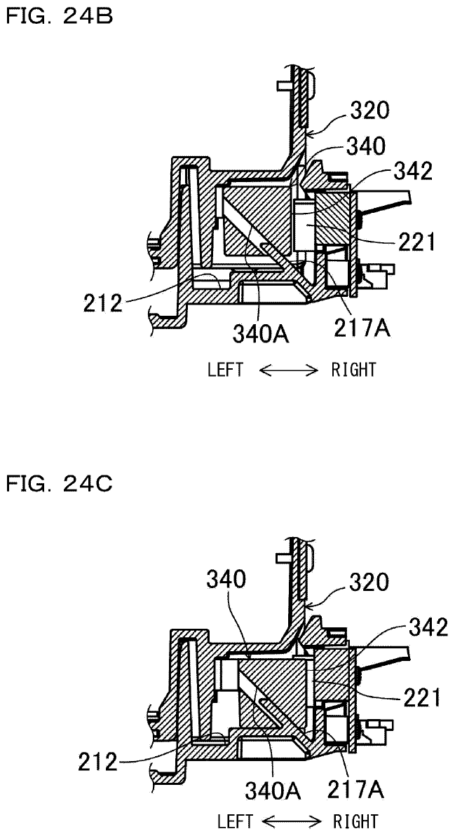

FIGS. 24A to 24C are cross-sectional views of the periphery of a ROM unit 340 and a switching section 217 according to Modification 2 of the embodiment of the present invention. In this Modification 2, a hole 343 is formed in the holding member 340A. The hole 340A is inclined so as to be located lower toward the right side. On the other hand, a projection 217A to be inserted into the hole 340A is formed on the bottom surface 212 of the cartridge receiving section 210. The projection 217A is inclined so as to be positioned upward toward the left side, and is an example of a switching section for switching the holding member 343 in the retracted position to the advanced position. As illustrated in FIG. 24A, when the cartridge 300 enters the cartridge receiving section 210, the upper end portion of the projection 217A is in a positional relationship facing the lower end portion of the hole 340A. As illustrated in FIG. 24B, when the cartridge 300 moves downward, the upper end portion of the projection 217A is inserted into the lower end portion of the hole 340A. When the cartridge 300 further moves downward and is completely attached to the cartridge receiving section 210, the holding member 343 is switched to the advanced position by the projection 217A. As described above, the holding member 343 can also be switched to the advanced position by the hole 340A and the projection 217A.

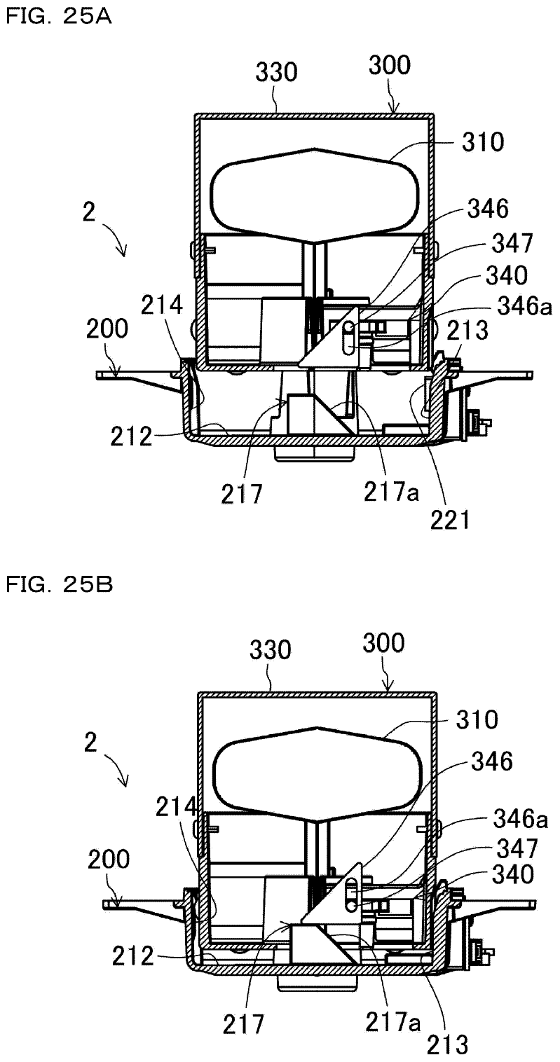

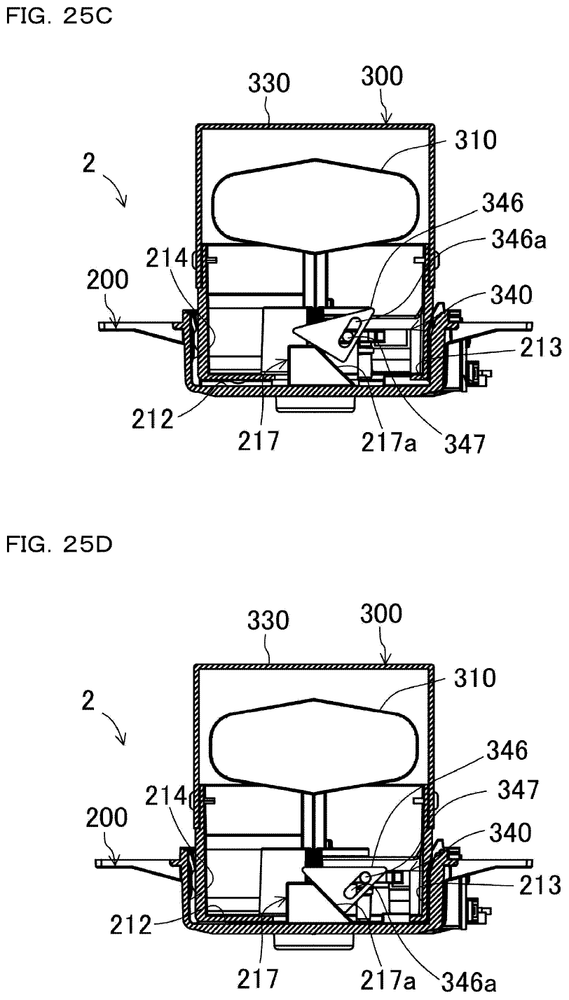

FIGS. 25A to 25D are cross-sectional views of the periphery of a ROM unit 340 and a switching section 217 according to Modification 3 of the embodiment of the present invention. In this Modification 3, the holding member 343 is provided with a triangular link 346. A long hole 346a long in the up-down direction is formed in the triangular link 346. A shaft 347 extending in the front-rear direction is inserted into the long hole 346a of the triangular link 346. As a result, the triangular link 346 becomes rotatable around the shaft 347 and becomes relatively movable in the longitudinal direction of the long hole 346a.

As illustrated in FIG. 25A, when the cartridge 300 enters the cartridge receiving section 210, the left side portion of the triangular link 346 with respect to the shaft 347 is in a positional relationship of facing the upper end portion of the body-side inclined surface 217a. As illustrated in FIG. 25B, when the cartridge 300 moves downward, the left side portion of the triangular link 346 with respect to the shaft 347 is pushed upward by the upper end portion of the body-side inclined surface 217a. As a result, as illustrated in FIG. 25C, the triangular link 346 starts to rotate around the shaft 347 and starts to move upward relative to the shaft 347. The triangular link 346 and the holding member 343 are engaged, and the holding member 343 is pushed in the advancing direction by the movement of the triangular link 346 and starts to move. Then, as illustrated in FIG. 25D, when the cartridge 300 further moves downward and is completely attached to the cartridge receiving section 210, the triangular link 346 is guided while being in contact with the body-side inclined surface 217a, and accordingly, the holding member 343 is switched to the advanced position.

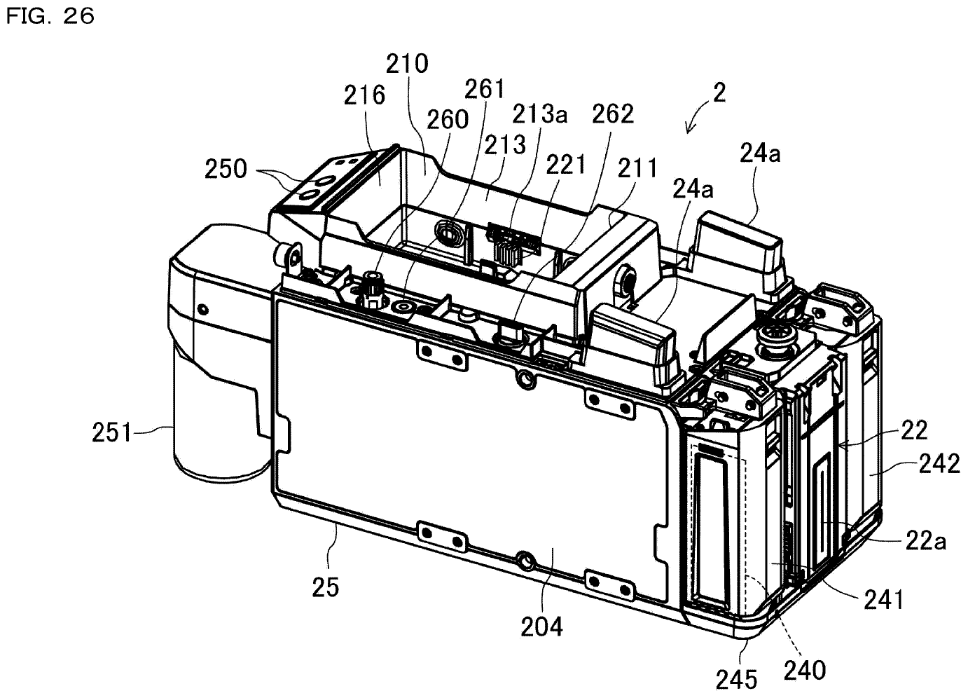

As illustrated in FIG. 5 and the like, the drawing machine 2 includes an upper cover 230 detachable from the drawing machine body 25. FIG. 26 illustrates a state in which the upper cover 230 is detached. The drawing machine 2 includes an absorber 240 (illustrated only in FIG. 26) for absorbing the ink leaking from the print head 22, and a casing 241 for accommodating the absorber 240. The absorber 240 is made of sponge, fiber, or the like.

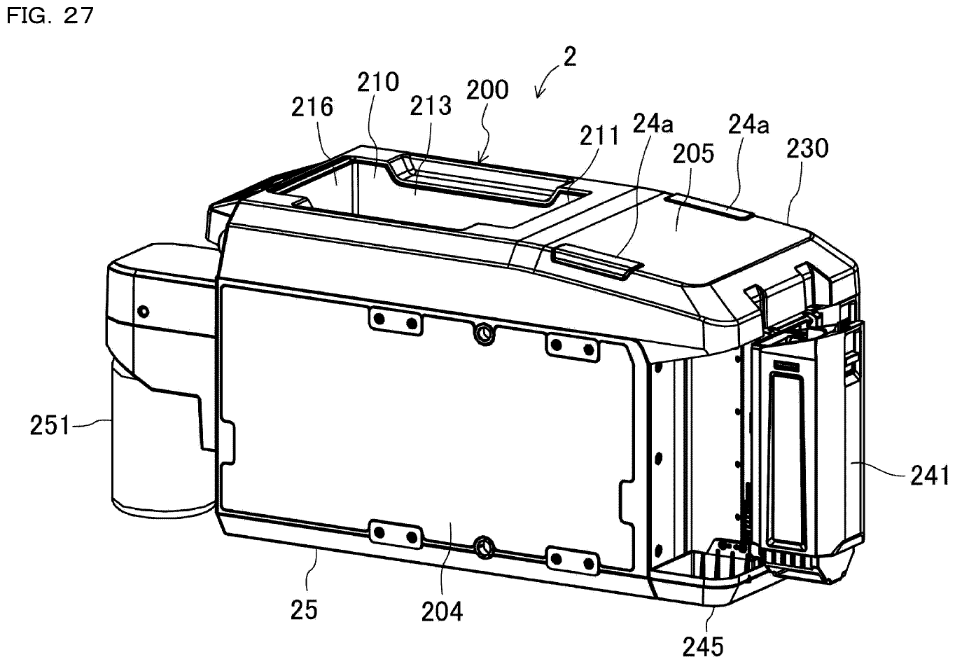

The casing 241 has a shape elongated in the up-down direction, and is detachably provided on the left side of the print head 22 on the front surface 201 of the housing 200. FIG. 27 illustrates a state in which the casing 241 is detached from the drawing machine body 25 and moved forward. As illustrated in FIG. 27, only the casing 241 can be detached from the drawing machine body 25 and replaced without detaching the upper cover 230.

The absorber 240 is provided only on one of the left side and the right side of the drawing machine body 25. In this example, since the casing 241 accommodating the absorber 240 is provided on the left side of the drawing machine body 25, the absorber 240 is not provided on the right side of the drawing machine body 25. Therefore, on the right side of the drawing machine body 25, a box-shaped member 242 that does not accommodate the absorber 240 is detachably provided. The shape of the box-shaped member 242 is bilaterally symmetrical with the casing 241. Note that, in a case where the absorber 240 is provided on the left side of the drawing machine body 25, the casing 241 accommodating the absorber 240 may be detachably provided on the left side of the drawing machine body 25, and the box-shaped member 242 may be detachably provided on the right side.

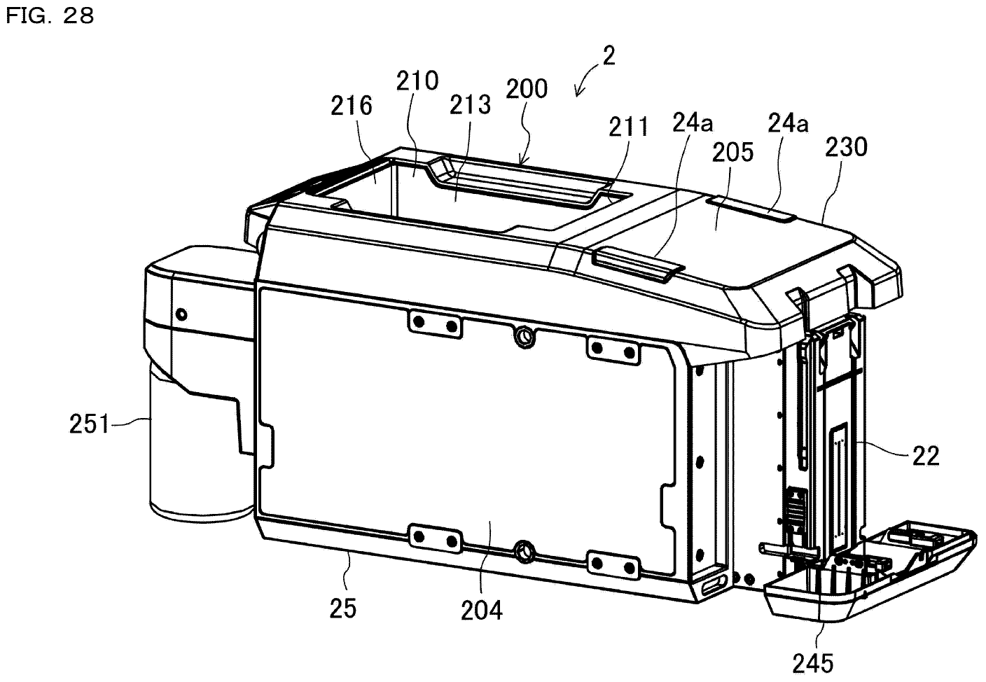

An ink reception portion 245 having a liquid feeding structure for guiding the ink leaking from the print head 22 to the absorber 240 is provided below the print head 22 in the drawing machine body 25. The ink reception portion 245 is detachably provided on a lower portion of the front surface 201 of the drawing machine body 25. FIG. 28 illustrates a state in which the casing 241, the box-shaped member 242, and the ink reception portion 245 are detached from the drawing machine body 25, and the ink reception portion 245 is moved forward.

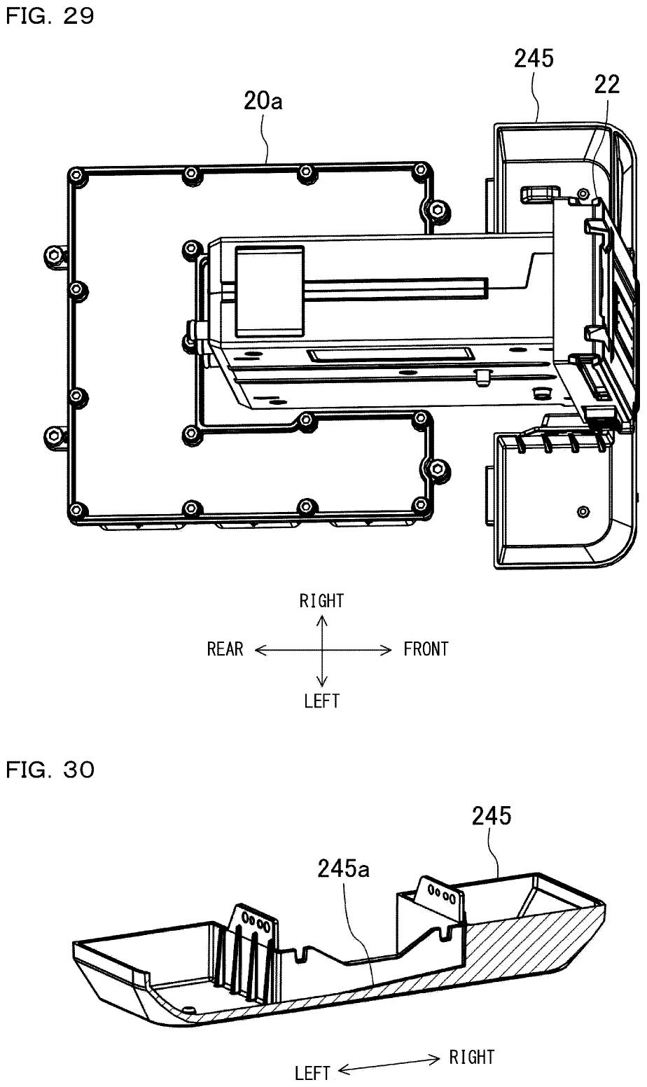

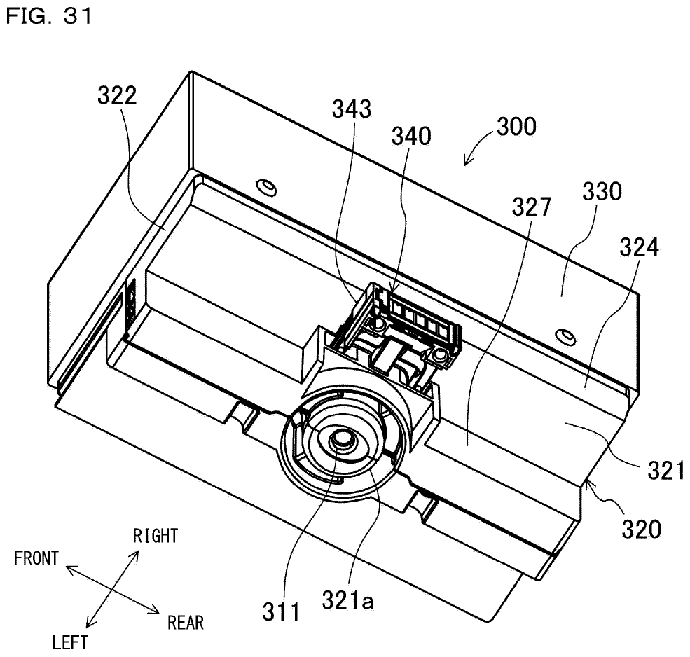

As illustrated in FIG. 29, the ink reception portion 245 is formed so as to extend to the left side and the right side below the print head 22, and has a concave shape that opens upward as a whole. The casing 241 accommodating the absorber 240 is located above the left side of the ink reception portion 245, while the box-shaped member 242 is located above the right side of the ink reception portion 245. As illustrated in FIG. 30, the bottom surface 245a of the ink reception portion 245 is inclined downward from the central portion in the left-right direction toward the left side. As a result, the ink leaking from the print head 22 can be received by the bottom surface 245a of the ink reception portion 245 and then flow to the left side, that is, the side where the absorber 240 is provided, so the ink can be reliably absorbed by the absorber 240. Note that, in a case where the absorber 240 is provided on the right side, the ink reception portion 245 having the bottom surface 245a inclined in the opposite direction may be attached.

FIG. 29 illustrates a positional relationship between the ink tank 20a and the print head 22. The ink tank 20a is installed in a lower portion of the drawing machine body 25. As illustrated in FIG. 29, the ink tank 20a is formed so as to be disposed behind the print head 22 and on the left side and the right side of the print head 22 in plan view, and is not disposed in front of the print head 22. That is, the ink tank 20a of the present embodiment is provided so as to surround a portion other than the side having the nozzle group 22a in the print head 22 in plan view. In other words, it is provided so as to surround at least two of the three sides other than the side having the nozzle group 22a in the print head 22.

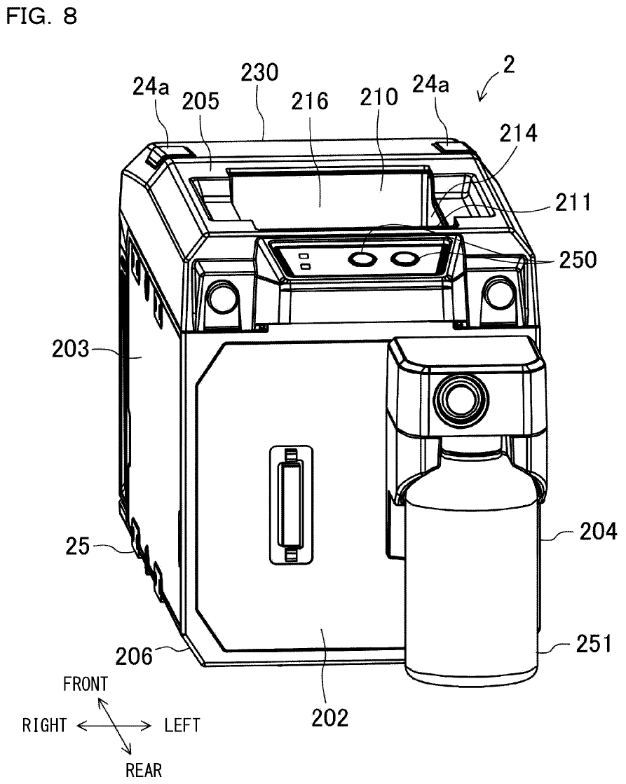

As illustrated in FIGS. 8 and 9, the drawing machine 2 includes an operation button 250. The operation button 250 is a member that receives a user instruction for controlling the drawing machine 2. The number of operation buttons 250 may be one or two or more. The operation button 250 is provided on the upper portion of the rear surface 202 of the housing 200 and is located on the side opposite to the print head 22 side. As a result, the user can operate the operation button 250 from the side opposite to the conveyor 10, and thus operability is improved. Examples of the operation button 250 include a test button to be operated in a case where test drawing is performed, a cleaning button to be operated in a case where the drawing machine 2 is cleaned, and the like, but the operation button may be a button to execute any function.

The drawing machine 2 includes a waste liquid bottle 251. The waste liquid bottle 251 is provided on the rear surface 202 of the housing 200 and is located on the side opposite to the print head 22 side. The waste liquid bottle 251 is a container for storing ink that has been supplied from the ink tank 20a to the print head 22 and has not been ejected toward the workpiece W. An ink inflow port (not illustrated), which is an opening of the waste liquid bottle 251, is provided in the upper portion of the waste liquid bottle 251, and is formed at a position higher than the liquid level of the ink accommodated in the ink tank 20a (illustrated in FIG. 29). The ink that has been supplied to the print head 22 and has not been ejected toward the workpiece W is fed to the opening of the waste liquid bottle 251 by the feeder, and then flows into the waste liquid bottle 251 from the opening. The waste liquid bottle 251 is configured to be detachable from the drawing machine body 25, and can discharge ink in the waste liquid bottle 251 as necessary.

As illustrated in FIG. 2, the drawing machine 2 includes an indicator lamp 24a and a lighting display control section 24b. The indicator lamp 24a is a member for notifying the user of information related to the drawing of the drawing machine 2 by the lighting state, and can be constituted by, for example, a light emitting unit capable of emitting light in only one color or a plurality of different colors. The lighting display control section 24b is a part that controls the lighting state of the indicator lamp 24a. For example, in a case where normal drawing is being executed, the lighting display control unit controls the indicator lamp 24a to emit light in a first emission color, and in a case where abnormality occurs in drawing, the lighting display control unit controls the indicator lamp 24a to emit light in a second emission color different from the first emission color. Note that, in a case where normal drawing is being executed, the indicator lamp 24a may be turned off, and in a case where abnormality occurs in drawing, the indicator lamp 24a may be turned on or blink.

The indicator lamp 24a is provided on the front side of the cartridge receiving section 210 on the upper surface 205 of the housing 200. In this embodiment, the two indicator lamps 24a are provided on each of the left and right sides of the upper surface 205 of the housing 200, but only one indicator lamp 24a may be provided. Since the user does not need to access the indicator lamp 24a, the usability of the drawing machine 2 is not affected even if the indicator lamp 24a is provided on the front side of the cartridge receiving section 210.

Furthermore, as illustrated in a state where the upper cover 230 is detached in FIG. 26, an air filter 260 for filtering air sucked into the drawing machine body 25, a level 261, and a hand valve 262 for opening and closing an internal pipeline by manual operation are provided on the upper side of the drawing machine body 25. The air filter 260, the level 261, and the hand valve 262 are arranged in the front-rear direction on the side of the cartridge receiving section 210. When the upper cover 230 is attached to the drawing machine body 25, the air filter 260, the level 261, and the hand valve 262 are covered by the upper cover 230 and cannot be seen from the outside.

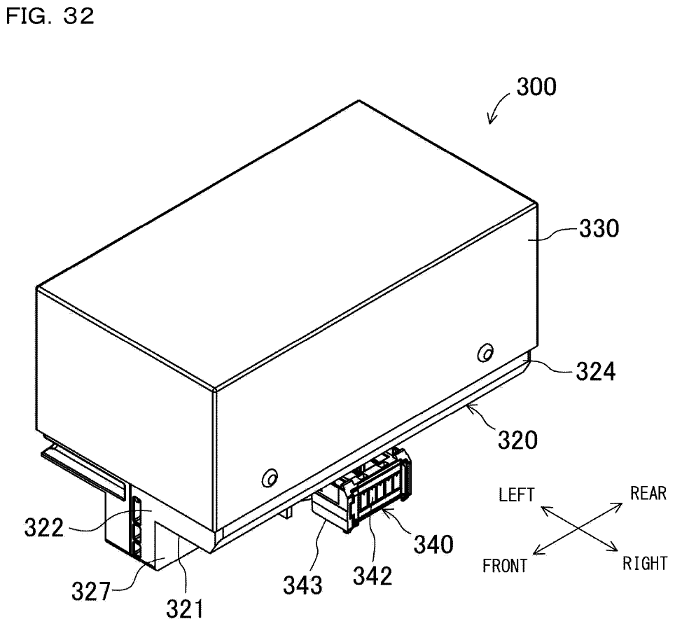

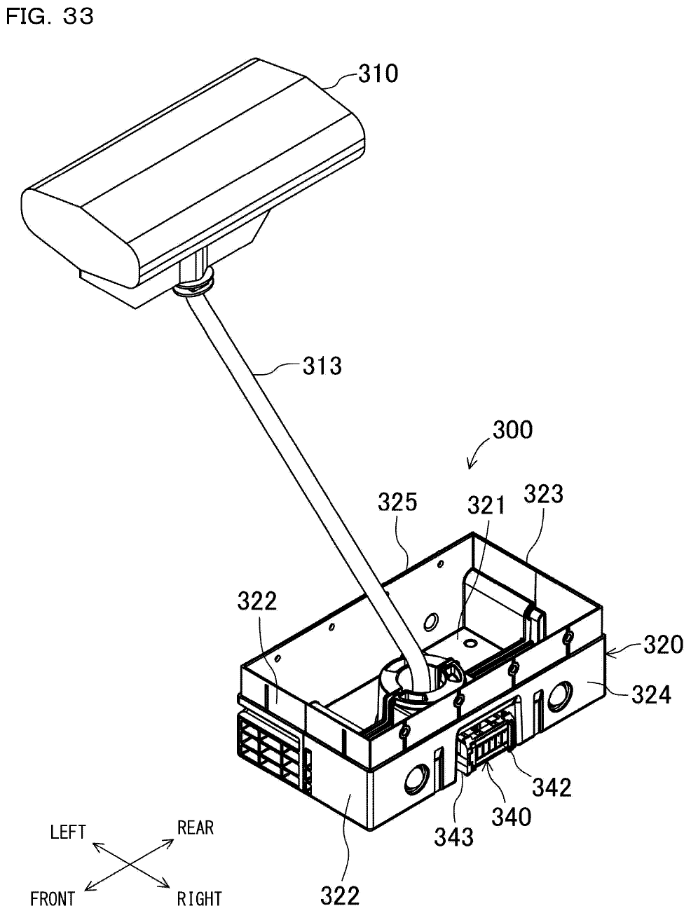

FIGS. 31 and 32 illustrate a cartridge 300 according to Modification 4 of the embodiment. In Modification 4, the ROM unit 340 is supported by the support portion 327 protruding downward from the bottom wall portion 321 of the outer case 320. As in this Modification 4, the ROM unit 340 may be supported by a wall portion other than the right side wall portion 324 of the outer case 320. The support portion 327 protruding from the bottom wall portion 321 can be referred to as a portion that is provided on the wall portion of the outer case 320 and forms a new wall for supporting the ROM unit 340, that is, an expansion wall portion. The ROM unit 340 may be supported by the outer case 320 by attaching the ROM unit 340 to the expansion wall portion provided on a wall portion of the outer case 320. Furthermore, the expansion wall portion may be realized as an attachment detachably attached to the wall portion of the outer case 320.

FIG. 33 is a perspective view illustrating a structure of a cartridge 300 according to Modification 5 of the embodiment. In the cartridge 300 of Modification 5, the pouch 310 is separated from the outer case 320, and can be installed at a position away from the drawing machine body 25. In other words, the outer case 320 is formed to be semi-open and does not accommodate the pouch 310. The pouch 310 is provided with an ink tube 313 through which ink flows. Although not illustrated, the downstream end of the ink tube 313 is a mouth 311 including the rubber plug described above. The outer case 320 supports the mouth 311 such that the rubber plug is exposed to the outside. Furthermore, the pouch 310 may be exchangeably attached to and detached from the cartridge 300. When the end portions of the ink tube 313 and the pouch 310 can be attached and detached, and the ink accommodated in the pouch 300 is used up, the ink cannot be supplied to the drawing machine 2. However, by replacing the pouch 300 with a new one, the ink can be supplied to the drawing machine 2 again. The information on the ink recorded on the recording medium 341 is updated at the timing when the pouch 300 is replaced with a new one. Information on the ink accommodated in the new pouch 300 may be received from the drawing machine 2 via the access terminal 342 and written in the recording medium 341, or the recording medium 341 may be replaced with a new one corresponding to the new pouch 300.

Furthermore, although not illustrated, the ROM unit 340 may be directly attached to the mouth 311. Since the mouth 311 is positioned and supported by the outer case 320, the ROM unit 340 is indirectly supported by the outer case 320 via the mouth 311.

The above-described embodiments are merely examples in all respects, and should not be construed in a limiting manner. Moreover, all modifications and changes falling within the equivalent scope of the claims are within the scope of the present invention.

As described above, the drawing machine according to the present disclosure can be used, for example, when information is drawn on an object to be drawn conveyed by a conveyor.

What is claimed is:

1. A cartridge that is inserted into a cartridge receiving section provided in a drawing machine that ejects ink for drawing information on an object to be drawn conveyed by a conveyor and refills the drawing machine with the ink, the cartridge comprising:
an ink accommodation section configured to accommodate the ink;
a conduit member including a flow path communicating with an internal space of the ink accommodation section;
an outer case configured to support the conduit member and expose one end of the conduit member to an outside;
a recording medium configured to record information regarding the cartridge;
an access terminal electrically connected to the recording medium and configured to be accessed from a terminal on a side of the drawing machine via the cartridge receiving section; and
a holding member configured to hold the recording medium and the access terminal and be supported by the outer case to be switchable between an advanced position where the access terminal is in contact with the terminal on the side of the drawing machine and a retracted position where the access terminal is away from the terminal on the side of the drawing machine.

2. The cartridge according to claim 1, wherein
the conduit member has higher rigidity than the ink accommodation section,
the outer case includes a bottom wall portion configured to hold the conduit member and a side wall portion rising from an edge of the bottom wall portion, and
the side wall portion includes a recess in which the holding member is accommodated.

3. The cartridge according to claim 2, wherein
the holding member slides in a direction orthogonal to the side wall portion of the outer case.

4. The cartridge according to claim 3, further comprising a guide portion configured to guide the holding member in a direction orthogonal to the side wall portion of the outer case.

5. The cartridge according to claim 2, wherein
the bottom wall portion of the outer case has a shape elongated in a predetermined direction,
the conduit member is held at an intermediate portion in a lateral direction of the bottom wall portion, and
the access terminal is provided on a side wall portion rising from an edge extending in a longitudinal direction of the bottom wall portion.

6. The cartridge according to claim 1, wherein
the ink accommodation section is configured by a pouch in which the ink is sealed.

7. The cartridge according to claim 6, wherein
the outer case has a shape elongated in a predetermined direction, and
the pouch has a shape elongated in a longitudinal direction of the outer case.

8. The cartridge according to claim 6, wherein
a gas is enclosed in the pouch together with the ink.

9. The cartridge according to claim 2, wherein
the conduit member is provided with a rubber plug configured to seal the flow path.

10. The cartridge according to claim 1, wherein
the holding member is attached to the conduit member and is supported by the outer case via the conduit member.

11. A cartridge that is inserted into a cartridge receiving section provided in a drawing machine that ejects ink for drawing information on an object to be drawn conveyed by a conveyor and refills the drawing machine with the ink, the cartridge comprising:
a conduit member including a flow path communicating with an internal space of an ink accommodation section configured to accommodate the ink;
an outer case configured to support the conduit member and expose one end of the conduit member to an outside;
a recording medium configured to record information regarding the cartridge;
an access terminal electrically connected to the recording medium and configured to be accessed from a terminal on a side of the drawing machine via the cartridge receiving section; and
a holding member configured to hold the recording medium and the access terminal and be supported by the outer case to be switchable between an advanced position where the access terminal is in contact with the terminal on the side of the drawing machine and a retracted position where the access terminal is away from the terminal on the side of the drawing machine.
